(19) United States
(12) Patent Application Publication
(10) Pub. No.: US 2016/0274787 A1
(43) Pub. Date: Sep. 22, 2016

(54) APPARATUS FOR OPERATING ROBOTS

(71) Applicant: DENSO WAVE INCORPORATED, Chita-gun, Aichi-pref. (JP)

(72) Inventors: Atsuko SUGANO, Kariya-shi (JP); Hirota TOUMA, Obu-shi (JP)

(73) Assignee: DENSO WAVE INCORPORATED, Chita-gun, Aichi-pref. (JP)

(21) Appl. No.: 15/075,876

(22) Filed: Mar. 21, 2016

(30) Foreign Application Priority Data
Mar. 19, 2015 (JP) 2015-056504
Dec. 14, 2015 (JP) 2015-243152

(51) Int. Cl. G06F 3/0488; G06F 3/0486; G06F 3/041

(52) U.S. Cl. CPC G06F 3/04883; G06F 3/0416; G06F 3/0486

(57) ABSTRACT

A robot operation apparatus includes a touch panel, operation detecting unit that is capable of detecting a touch operation or drag operation on touch panel, and motion command generating unit that generates motion command for operating a robot based on a detection result from operation detecting unit. The motion command generating unit is capable of performing a motion direction determining process in which a motion direction of the robot is determined, and a motion speed determining process in which, when the operation detecting unit detects a drag operation in a positive or negative direction in a specific linear direction on the touch panel after the motion direction determining process is performed, a motion speed Vr for operating the robot in the motion direction determined in the motion direction determining process is determined based on an absolute value |Vd| of an operating speed Vd of the drag operation.

### CROSS-REFERENCE TO RELATED APPLICATION

This application is based on and claims the benefit of priority from earlier Japanese Patent Application No. 2015-243152 filed Dec. 14, 2015, the descriptions of which are incorporated herein by reference.

### BACKGROUND

1. Technical Field

The present invention relates to a robot operation apparatus that is used when a robot is manually operated.

2. Background Art

In a robot system for industrial use, manual operation in which a robot is manually operated is possible. Manual operation is used when a teaching operation (teaching), for example, is performed. In this case, a user manually operates the robot (referred to as manual operation or manual operation) using a teaching pendant or the like that is connected to a controller that controls the robot.

Many teaching pendants are provided with a touch panel that can be touch-operated. Among teaching pendants that are provided with a touch panel, some enable the user to manually operate the robot by performing a so-called drag operation, that is, by performing an operation in which a finger, a dedicated pen, or the like is traced over the touch panel.

### CITATION LIST

### Patent Literature

[PTL 1] JP-A-H11-262883

### SUMMARY OF INVENTION

### Technical Problem

However, the drag operation on the touch panel is an operation in which the finger of the user or the like is traced over the flat touch panel. Therefore, physical changes, such as in pressing force or tilt of a mechanical operating key, that are made when the operating key is operated are not possible. Therefore, compared to a teaching pendant in which a mechanical operating key is operated, in a teaching pendant in which a drag operation is performed on a touch panel, the user has difficulty in attaining a sense of operation and intuitive operation becomes difficult.

### SUMMARY

The present invention has been achieved in light of the above-described issue. An object of the present invention is to provide a robot operation apparatus that performs manual operation of a robot by a drag operation being inputted on a touch panel and is capable of improving operability by the user by enabling intuitive operation, and a robot operation program used in the robot operation apparatus.

### Solution to Problem

A robot operation (or manipulation) apparatus according to claim 1 includes: a touch panel that receives input of a touch operation and a drag operation from a user; an operation detecting unit that is capable of detecting the touch operation and the drag operation on the touch panel; and a motion command generating unit that generates a motion command for operating the robot based on a detection result from the operation detecting unit. That is, the robot operation apparatus actualizes manual operation of a robot by a touch operation and a drag operation.

Here, the touch operation refers to an operation in which a finger of a user, a pen device, or the like (referred to, hereafter, as the finger or the like) comes into contact with, that is, touches a touch panel. In addition, the drag operation is performed continuously from the touch operation, and refers to an operation in which the finger of the user or the like is moved over the touch panel while the finger or the like remains in contact with the touch panel. In other words, the drag operation is an operation in which the finger of the user or the like is continuously moved over a fixed distance while in contact with the touch panel.

In addition, in the robot operation apparatus, the motion command generating unit is capable of performing a motion direction determining process and a motion speed determining process. The motion direction determining process is a process in which a motion direction of the robot is determined. The motion speed determining process is a process in which, when the operation detecting unit detects a drag operation in a positive or negative direction in a specific linear direction on the touch panel after the motion direction determining process is performed, a motion speed Vr for operating the robot in the motion direction determined in the motion direction determining process is determined based on an absolute value |Vd| of an operating speed Vd of the drag operation

That is, in this configuration, when the motion direction of the robot is determined and a drag operation in the positive or negative direction in the specific linear direction is performed on the touch panel, the motion speed Vr of the robot is determined based on the absolute value |Vd| of the operating speed Vd of the drag operation. In other words, in the drag operation performed to determine the motion speed Vr of the robot, the positive/negative direction of the drag operation does not affect the motion direction of the robot. Therefore, the user can continue to make the robot operate at the motion speed Vr corresponding to the operating speed of the drag operation by performing the drag operation such as to move back and forth on a specific straight line on the touch panel, that is, such as to rub the touch panel display with the finger or the like.

For example, when the user continues to perform the drag operation such as to move back and forth in a certain direction at a high operating speed, that is, when the user continues to rub the touch panel with the finger or the like at a high speed, the robot continues to operate at a high motion speed Vr corresponding to the high operating speed. Meanwhile, when the user continues to perform the drag operation such as to move back and forth in a certain direction at a low operating speed, that is, when the user continues to rub the touch panel with the finger or the like at a low speed, the robot continues to operate at a low motion speed Vr corresponding to the low operating speed. Then, when the user stops the drag operation, the robot also stops.

In this way, in the present robot operation apparatus, the user can continue to make the robot operate by continuously moving their finger or the like, and stop the robot by stopping their finger or the like. In addition, the user can adjust the motion speed Vr of the robot by adjusting the movement speed of their finger or the like. As a result, the user easily receives the impression that the movement of the finger or the like by their drag operation and the motion of the robot are correlated. Consequently, the user can directly and intuitively determine the correlation between the drag operation performed by the user themselves and the motion of the robot performed as a result of the drag operation. As a result, user operability can be improved.

Furthermore, in the present robot operation apparatus, the motion of the robot can be continued by the user continuously performing the drag operation such as to move back and forth on the touch panel. Therefore, the user can continue to perform the drag operation for operating the robot without being restricted by the screen size of the touch panel. Consequently, for example, the motion of the robot being unintentionally stopped during teaching as a result of the drag operation not being able to be continued due to restriction by the screen size of the touch panel can be prevented. As a result, operability, such as in teaching, is improved. In addition, because continuation of the drag operation for operating the robot is not restricted by the screen size of the touch panel, the touch panel can be reduced in size.

In addition, in the present robot operation apparatus, the motion distance of the robot is the motion speed Vr of the robot multiplied by the amount of time over which the drag operation is performed, that is, the operating time. In addition, the motion speed Vr of the robot is correlated with the operating speed of the drag operation. In other words, the motion distance of the robot is correlated with a value obtained by the operating speed of the drag operation being multiplied by the operating time of the drag operation, that is, the movement distance of the finger or the like in the drag operation. In this case, for example, when the movement distance of the finger or the like in the drag operation is short, the motion distance of the robot becomes short. When the movement distance of the finger or the like in the drag operation is long, the motion distance of the robot becomes long. That is, the user can shorten the motion distance of the robot by shortening the user can shorten the motion distance of the robot by shortening the movement distance of the finger or the like by, for example, performing a drag operation in which the finger or the like is moved back and forth in small motions. In addition, the user can lengthen the motion distance of the robot by lengthening the movement distance of the finger or the like by, for example, performing a drag operation in which the finger or the like is moved back and forth in large motions.

In this way, in the present robot operation apparatus, the user can adjust the motion distance of the robot by adjusting the movement distance of the finger or the like in their drag operation. Consequently, the user easily receives the sensation that the movement distance of the finger or the like in their drag operation is reflected in the motion distance of the robot. That is, the user can directly and intuitively determine the correlation between the drag operation performed by the user themselves and the motion of the robot performed as a result of the drag operation. As a result, user operability can be improved.

In a robot operation apparatus according to claim 2, the motion direction determining process includes a process in which the motion direction of the robot is determined to be a positive direction when the operating direction immediately after start of the drag operation is the positive direction in the specific linear direction, and the motion direction of the robot is determined to be a negative direction when the operating direction immediately after start of the drag operation is the negative direction in the specific linear direction. That is, the motion direction of the robot is determined by the operating direction immediately after the start of the drag operation. The motion speed Vr of the robot is determined by the absolute value |Vd| of the operating speed Vd of the drag operation that is subsequently continuously performed. Consequently, the user is not required to perform a separate operation to determine the motion direction of the robot. The user can perform both the operation to determine the motion direction and the operation to determine the motion speed Vr of the robot by a series of drag operations. As a result, the hassle of performing operations can be reduced and operability is improved.

Other characteristics are described in the embodiments disclosed below together with accompanying drawings.

### BRIEF DESCRIPTION OF THE DRAWINGS

In the accompanying drawings:

FIG. 1 is an overall configuration diagram of an example of a robot system using a four-axis, horizontal articulated robot according to a first embodiment;

FIG. 2 is an overall configuration diagram of an example of a robot system using a six-axis, vertical articulated robot according to the first embodiment;

FIG. 3 is a block diagram of an example of an electrical configuration of a teaching pendant according to the first embodiment;

FIG. 4 is a flowchart (1) of an example of details of various processes performed by a control unit according to the first embodiment;

FIG. 5 is a flowchart (2) of the details of the various processes performed by the control unit according to the first embodiment;

FIG. 6 is a diagram of an example of display content on a touch panel display immediately after manual operation is started, according to the first embodiment;

FIG. 7 is a diagram of an example of when a direction graphics is displayed on the touch panel display as a result of a touch operation being detected, according to the first embodiment;

FIG. 8 is a diagram of an example of display content displayed on the touch panel display when an operating direction immediately after the start of a drag operation is a first direction and a positive direction, according to the first embodiment;

FIG. 9 is a diagram (1) of an example of display content displayed on the touch panel display when a slider is moved back and forth, when the operating direction immediately after the start of a drag operation is the first direction and the positive direction, according to the first embodiment;

FIG. 10 is a diagram (2) of the example of display content displayed on the touch panel display when the slider is moved back and forth, when the operating direction immediately after the start of a drag operation is the first direction and the positive direction, according to the first embodiment;

FIG. 11 is a diagram of an example of display content displayed on the touch panel display when the operating direction immediately after the start of a drag operation is a second direction and a negative direction, according to the first embodiment;

FIG. 12 is a diagram (1) of an example of display content displayed on the touch panel display when a slider is moved back and forth, when the operating direction immediately after the start of a drag operation is the second direction and the negative direction, according to the first embodiment;

FIG. 13 is a diagram (2) of the example of display content displayed on the touch panel display when the slider is moved back and forth, when the operating direction immediately after the start of a drag operation is the second direction and the negative direction, according to the first embodiment;

FIG. 14 is diagrams showing a relationship between an operating speed of a drag operation and a motion speed of a robot, according to the first embodiment, in which (a) is a drawing indicating the operating speed of the drag operation and (b) is a diagram indicating a motion speed Vr of the robot corresponding to the operating speed;

FIG. 15 is a flowchart of an example of details of various processes performed by a control unit according to a second embodiment;

FIG. 16 is a diagram of an example of a motion mode selection screen for a four-axis robot displayed on a touch panel display according to the second embodiment;

FIG. 17 is a diagram of an example of a motion mode selection screen for a six-axis robot displayed on a touch panel display according to the second embodiment;

FIG. 18 is a diagram of an example of a touch operation on the motion mode selection screen for the four-axis robot according to the second embodiment;

FIG. 19 is a diagram (1) of an example of display content displayed on the touch panel display according to the second embodiment;

FIG. 20 is a diagram (2) of the example of display content displayed on the touch panel display according to the second embodiment;

FIG. 21 is a diagram conceptually showing data on operating speed stored in a storage area according to a third embodiment;

FIG. 22 is a diagram (1) of an example of changes over time in an absolute value of an operating speed of a drag operation and correction values based on the absolute value, according to the third embodiment;

FIG. 23 is a diagram (2) of the example of changes over time in the absolute value of the operating speed of a drag operation and the correction values based on the absolute value, according to the third embodiment;

FIG. 24 is a diagram of an example of changes over time in an absolute value of an operating speed of a drag operation, and a simple moving average value, a weighted moving average value, and an exponential moving average value based on the absolute value, according to a fourth embodiment;

FIG. 25 is an enlarged view of section X25 in FIG. 24, according to the fourth embodiment;

FIG. 26 is an enlarged view of section X26 in FIG. 24, according to the fourth embodiment; and

FIG. 27 is an enlarged view of section X27 in FIG. 24, according to the fourth embodiment.

### DETAILED DESCRIPTION OF THE PREFERRED EMBODIMENTS

A plurality of embodiments of the present invention will hereinafter be described. Configurations according to the embodiments that are essentially the same are given the same reference numbers. Descriptions thereof will be omitted for a simplified description.

### First Embodiment

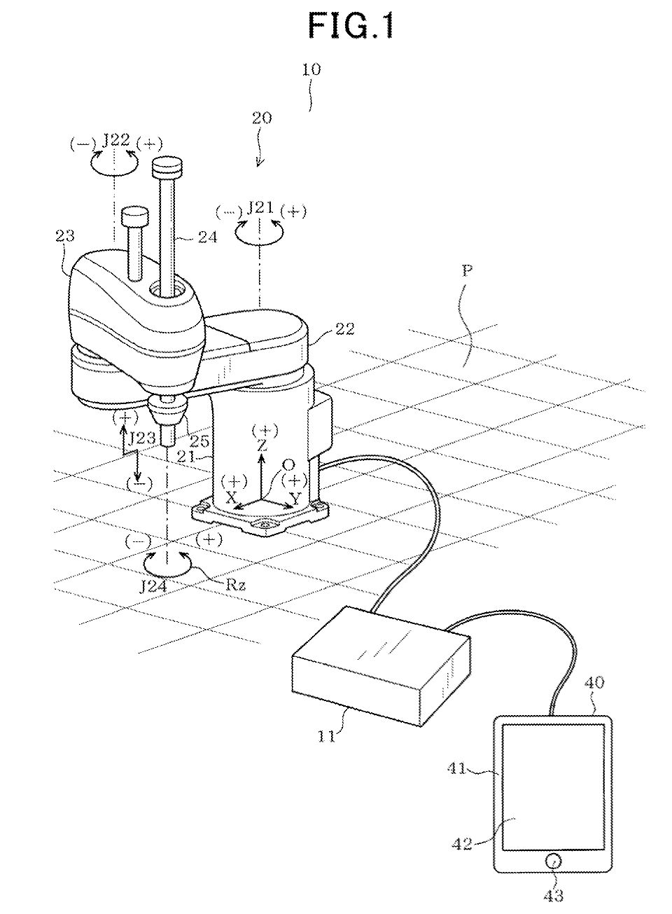

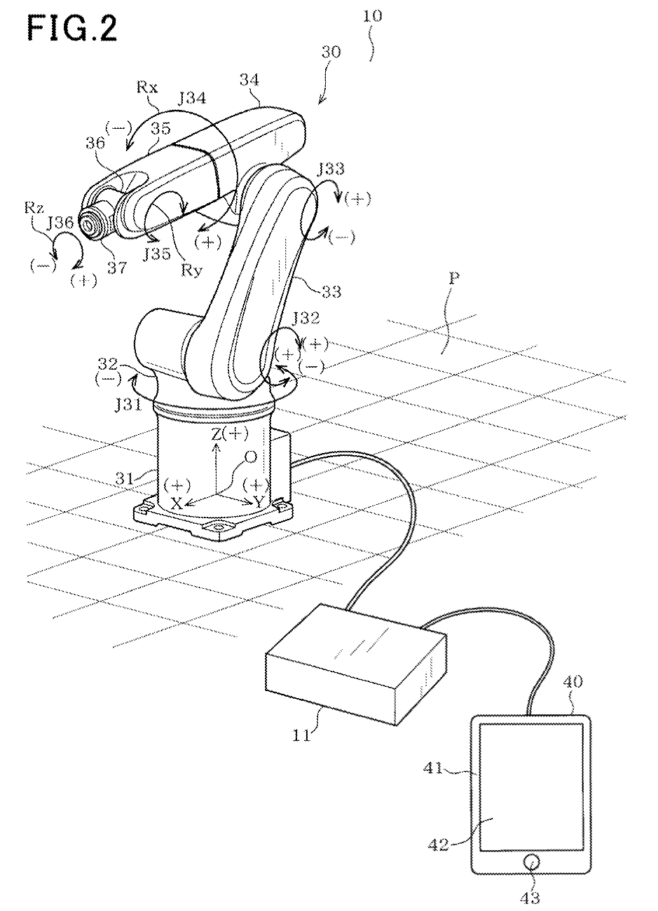

A first embodiment of the present invention will be described below, with reference to FIG. 1 to FIG. 14. FIG. 1 and FIG. 2 show a system configuration of a typical robot for industrial use. A robot system 10 operates, for example, a four-axis, horizontal articulated robot 20 (referred to, hereafter, as a four-axis robot 20) shown in FIG. 1 or a six-axis, vertical articulated robot 30 (referred to, hereafter, as a six-axis robot 30) shown in FIG. 2. The robot to be operated by the robot system 10 is not limited to the above-described four-axis robot 20 and six-axis robot 30.

First, an overall configuration of the four-axis robot 20 shown in FIG. 1 will be described. The four-axis robot 20 operates or is manipulated based on a unique robot coordinate system (a three-dimensional orthogonal coordinate system composed of an X-axis, a Y-axis, and a Z-axis). According to the present embodiment, in the robot coordinate system, the center of a base 21 is defined as a point of origin O, a top surface of a work table P is defined as an X-Y plane, and a coordinate axis perpendicular to the X-Y plane is defined as the Z-axis. The top surface of the work table P is an installation surface for installing the four-axis robot 20. In this case, the installation surface corresponds to a motion reference plane. The motion reference plane is not limited to the installation surface and may be an arbitrary plane.

The four-axis robot 20 has the base 21, a first arm 22, a second arm 23, a shaft 24, and a flange 25. The base 21 is fixed to the top surface (also referred to, hereafter, as the installation surface) of the work table P. The first arm 22 is connected to an upper portion of the base 21 such as to be capable of rotating around a first axis J21. The first axis J21 has a shaft center in the Z-axis (vertical-axis) direction. The second arm 23 is connected to an upper portion of a tip end portion of the first arm 22 such as to be capable of rotating around a second axis J22. The second axis J22 has a shaft center in the Z-axis direction. The shaft 24 is provided in a tip end portion of the second arm 23 such as to be capable of moving up and down and to be capable of rotating. In addition, an axis for when the shaft 24 is moved up and down is a third axis J23. An axis for when the shaft 24 is rotated is a fourth axis J24. The flange 25 is detachably attached to a tip end portion, that is, a lower end portion of the shaft 24.

The base 21, the first arm 22, the second arm 23, the shaft 24, and the flange 25 function as an arm of the four-axis robot 20. An end effector (not shown) is attached to the flange 25 that is the arm tip. For example, when component inspection or the like is performed using the four-axis robot 20, a camera for imaging the component to be inspected or the like is used as the end effector. The plurality of axes (J21 to J24) provided in the four-axis robot 20 are driven by motors (not shown) respectively provided in correspondence thereto. A position detector (not shown) for detecting a rotation angle of a rotation shaft of the motor is provided near each motor.

When an articulated-type robot is manually operated, the motions of the robot include a motion of an axis system in which the drive axes are individually driven, and a motion of an end effector system in which the end effector of the robot is moved over an arbitrary coordinate system by a plurality of drive axes being driven in combination. In this case, in the motion of the axis system, the four-axis robot 20 can individually drive the drive axes J21 to J24. In addition, in the motion of the end effector system, the four-axis robot 20 can, for example, perform: a motion in the X-Y plane direction in which the first axis J21 and the second axis J22 are combined; a motion in the Z direction by the third axis J23; and a motion in a Rz direction by the fourth axis J24.

Next, an overall configuration of the six-axis robot 30 shown in FIG. 2 will be described. In a manner similar to the four-axis robot 20, the six-axis robot 30 also operates based on a unique robot coordinate system (a three-dimensional orthogonal coordinate system composed of an X-axis, a Y-axis, and a Z-axis). The six-axis robot 30 has a base 31, a shoulder portion 32, a lower arm 33, a first upper arm 34, a second upper arm 35, a wrist 36, and a flange 37. The base 31 is fixed to the top surface of the work table P. The shoulder portion 32 is connected to an upper portion of the base 31 such as to be capable of rotating in a horizontal direction around a first axis J31. The first axis J31 has a shaft center in the Z-axis (vertical-axis) direction. The lower arm 33 is provided extending upward from the shoulder portion 32. The lower arm 33 is connected to the shoulder portion 32 such as to be capable of rotating in a vertical direction around a second axis J32. The second axis J32 has a shaft center in the Y-axis direction.

The first upper arm 34 is connected to a tip end portion of the lower arm 33, such as to be capable of rotating in the vertical direction around a third axis J33. The third axis J33 has a shaft center in the Y-axis direction. The second upper arm 35 is connected to a tip end portion of the first upper arm 34 such as to be capable of rotating in a twisting manner around a fourth axis J34. The fourth axis J34 has a shaft center in the X-axis direction. The wrist 36 is connected to a tip end portion of the second upper arm 35 such as to rotate in the vertical direction around a fifth axis J25. The fifth axis J25 has a shaft center in the Y-axis direction. The flange 37 is connected to the wrist 36 such as to be capable of rotating in a twisting manner around a sixth axis J36. The sixth axis J36 has a shaft center in the X-axis direction.

The base 31, the shoulder portion 32, the lower arm 33, the first upper arm 34, the second upper arm 35, the wrist 36, and the flange 37 function as an arm of the robot 30. A tool, such as an air chuck (not shown), is attached to the flange 37 (corresponding to the end effector) that is the arm tip. In a manner similar to the four-axis robot 20, the plurality of axes (J31 to J36) provided in the six-axis robot 30 are driven by motors (not shown) respectively provided in correspondence thereto. In addition, a position detector (not shown) for detecting a rotation angle of a rotation shaft of the motor is provided near each motor.

In the motion of the axis system, the six-axis robot 30 can individually drive the drive axes J31 to J36. In addition, in the motion of the end effector system, the six-axis robot 30 can perform a motion in which the end effector is rotated around two axes differing from the Z-axis, in addition to the motions that can be performed by the four-axis robot 20. The two axes are two axes (X-axis and Y-axis) that are perpendicular to each other and horizontal in relation to the installation surface P. In this case, the rotation direction around the X-axis is an Rx direction and the rotation direction around the Y-axis is an Ry direction. That is, in the motion of the end effector system, the six-axis robot 30 can, for example, perform: a motion in the X-Y plane direction in which the first axis J31, the second axis J32, and the third axis J33 are combined; a motion in a Z direction in which the second axis J32 and the third axis J33 are combined; a motion in the Rx direction by the fourth axis J34; a motion in the Ry direction by the fifth axis J35; and a motion in the Rz direction by the sixth axis.

In addition, the robot system 10 shown in FIG. 1 and FIG. 2 includes a controller 11 and a teaching pendant 40 (corresponding to a robot operation (or manipulation) apparatus), in addition to the robot 20 or the robot 30. The controller 11 controls or manipulates the robot 20 or 30. The controller 11 is connected to the robot 20 or 30 by a connection cable. The teaching pendant 40 is connected to the controller 11 by a connection cable. Data communication is performed between the controller 11 and the teaching pendant 40. As a result, various types of operating information inputted based on user operation are transmitted from the teaching pendant 40 to the controller 11. In addition, the controller 11 transmits various types of control signals, signals for display, and the like, and also supplies power for driving, to the teaching pendant 40. The teaching pendant 40 and the controller 11 may be connected by wireless communication.

When a signal issuing a command for manual operation is provided by the teaching pendant 4, the controller 3 performs control to enable the robot 20 or 30 to be manually operated. In addition, when a signal issuing a command for automatic operation is provided by the teaching pendant 4, the controller 11 performs control to enable the robot 20 or 30 to be automatically operated by startup of an automatic program that is stored in advance.

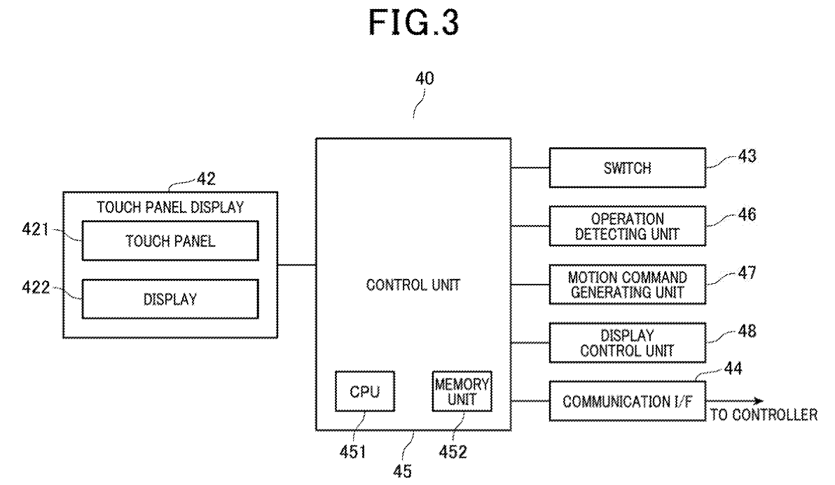

For example, the size of the teaching pendant 40 is to an extent that allows the user to carry the teaching pendant 40 or to operate the teaching pendant 40 while holding the teaching pendant 40 in their hand. The teaching pendant 40 is provided with, for example, a case 41, a touch panel display 42, and a switch 43. The case 41 is shaped like a thin, substantially rectangular box and configures an outer shell of the teaching pendant 40. The touch panel display 42 is provided so as to occupy a major portion of the front surface side of the case 41. As shown in FIG. 3, the touch panel display 42 has a touch panel 421 and a display 422, and is such that the touch panel 421 and the display 422 are arranged in an overlapping manner.

The touch panel display 42 is capable of receiving input of touch operations and drag operations by the user through the touch panel 421. In addition, the touch panel display 42 is capable of displaying images of characters, numbers, symbols, graphics, and the like through the display 422. The switch 43 is, for example, a physical switch and is provided in the periphery of the touch panel display 42. The switch 43 may be replaced with a button displayed on the touch panel display 42. The user performs various input operations by operating the touch panel display 42 and the switch 43.

The user can perform various functions such as operation and setting of the robot 20 or 30 using the teaching pendant 40. The user can also call up a control program stored in advance, and perform startup of the robot 20 or 30, setting of various parameters, and the like. In addition, the user can also perform various teaching operations by operating the robot 20 or 30 by manual operation, that is, operation by hand. In the touch panel display 42, for example, a menu screen, a setting input screen, a status display screen, and the like are displayed as required.

Next, an electrical configuration of the teaching pendant 40 will be described with reference to FIG. 1 The teaching pendant 40 has, in addition to the touch panel display 42 and the switch 43, a communication interface (I/F) 44, a control unit 45, an operation detecting unit 15, a motion command generating unit 47, and a display control unit 48. The communication interface 44 connects the control unit 45 of the teaching pendant 40 and the controller 11 to enable communication,

The control unit 45 is mainly configured by a microcomputer. The microcomputer includes, for example, a central processing unit (CPU) 451 and a storage area 452 (corresponding to a non-transitory computer readable medium), such as a read-only memory (ROM), a random access memory (RAM), and a rewritable flash memory. The control unit 45 controls the overall teaching pendant 40. The storage area 452 stores therein a robot operation program. The control unit 45 runs the robot operation program in the CPU 451, thereby functionally actualizing the operation detecting unit 46, the motion command generating unit 47, the display control unit 48, and the like through software. The operation detecting unit 46, the motion command generating unit 47, and the display control unit 48 may also be actualized by hardware as an integrated circuit that is integrated with the control unit 45, for example.

The operation detecting unit 46 is capable of detecting touch operations and drag operations performed on the touch panel 421. As detection of a touch operation, the operation detecting unit 46 is capable of detecting whether or not a finger of the user or the like has come into contact with the touch panel display 42, and the position (touch position) of the finger or the like that is in contact. In addition, as detection of a drag operation, the operation detecting unit 46 is capable of detecting a current position, a movement direction, a movement speed, and a movement amount of the finger or the like related to the drag operation.

The motion command generating unit 47 generates a motion command for operating the robot 20 or 30 based on the detection result from the operation detecting unit 46. The motion command generated by the motion command generating unit 47 is provided to the controller 11 via the communication interface 44. The display control unit 48 controls display content displayed on the display 422, based on operation of the switch 43, the detection result from the operation detecting unit 46, and the like. Through use of the teaching pendant 40 configured in this way, the user can perform manual operation of the robot 20 or 30 by touch operations and drag operations.

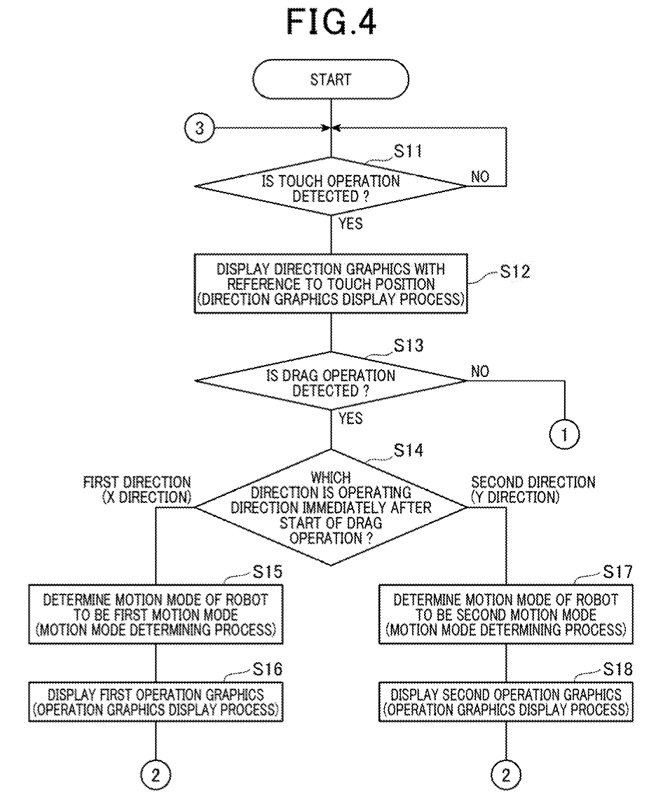

Next, details of control performed by the control unit 45 will be described with reference to FIG. 4 to FIG. 14. In the description below, when motion mode of the robot 20 or 30 is referred to, this indicates a motion mode of the robot 20 or 30 by a drive axis or a combination of drive axes of the robot 20 or 30. In this case, regarding motion systems, that is, the above-described end effector system and each axis system, the motion mode of the robot 20 or 30 does not include a movement direction in a positive (+) direction or a negative (−) direction of the motion system. In the description below, a case is described in which, in the motion of the end effector system of the robot 20 or 30, manual operation in the X-Y plane direction is performed on the same screen. In the teaching pendant 40, motion mode is not limited to the above-described motion mode of the end effector system in the X-Y plane direction. The robot 20 or 30 can be manually operated in an arbitrary motion mode of the axis system and the end effector system.

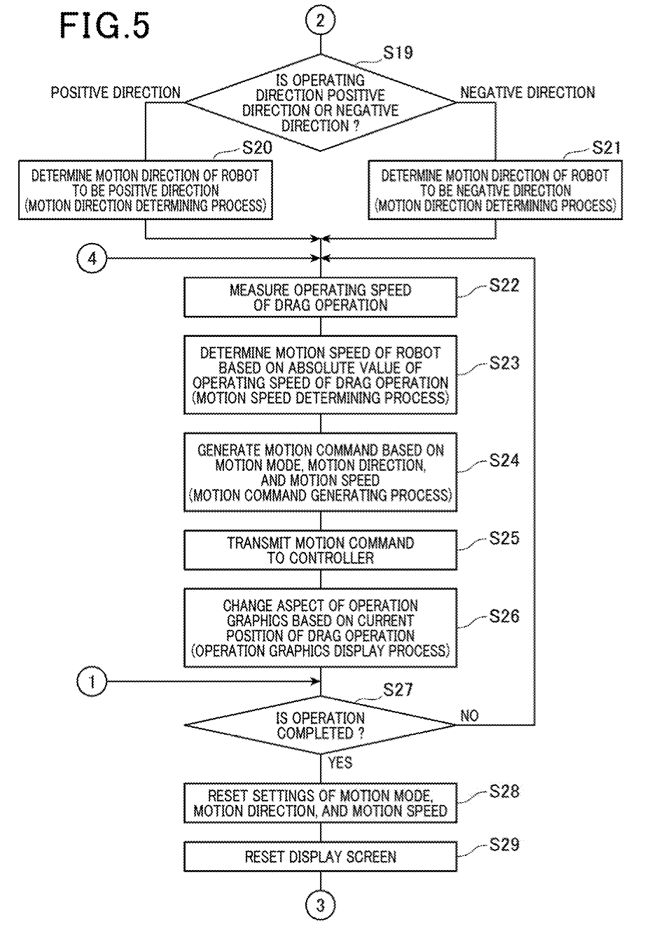

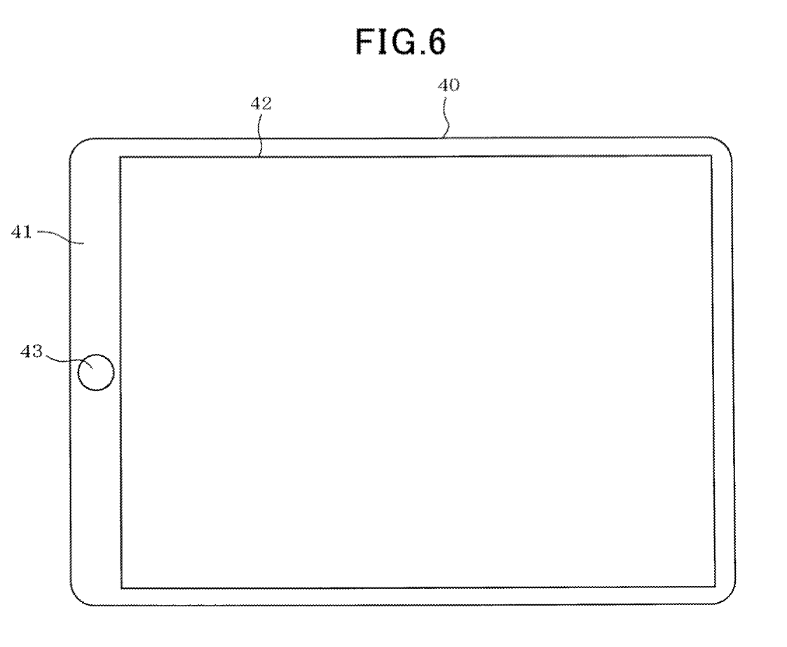

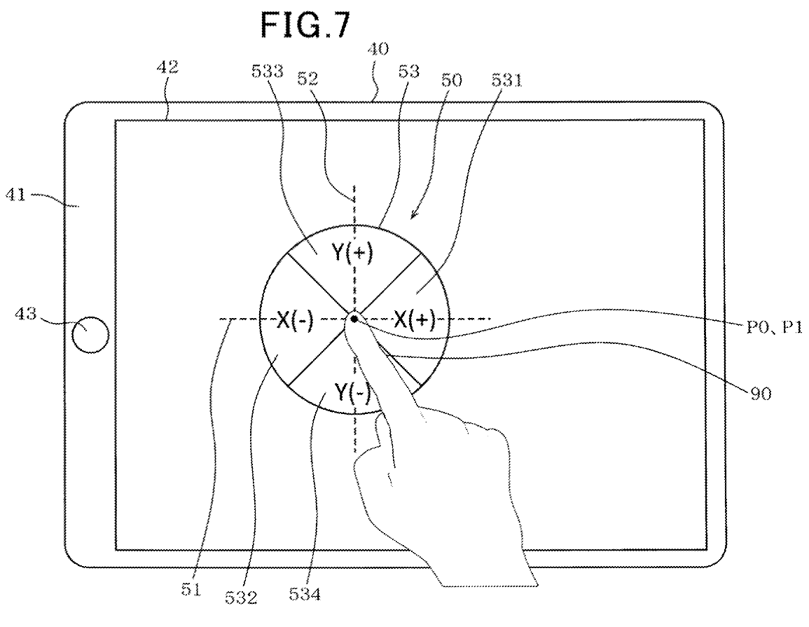

When manual operation of the robot 20 or 30 is started, the control unit 45 of the teaching pendant 40 performs control of which details are shown in FIG. 4 and FIG. 5. Specifically, when a process related to manual operation is started, first, at step S11 in FIG. 4, the control unit 45 determines whether or not a touch operation is performed on the touch panel display 42 based on a detection result from the operation detecting unit 46. When determined that a touch operation is not performed (NO at step S11), the control unit 45 displays nothing on the touch panel display 42, as shown in FIG. 6, and waits. Meanwhile, as shown in FIG. 7, when the user performs a touch operation on an arbitrary point on the touch panel display 42 with a finger 90 or the like, the control unit 45 determines that a touch operation is performed (YES at step S11) and performs step S12 in FIG. 4.

At step S12, the control unit 45 performs a direction graphics display process. The direction graphics display process is a process in which, when the operation detecting unit 46 detects a touch operation, as shown in FIG. 7, a direction graphics indicating a specific linear direction on the touch panel display 42, in this case, a direction graphic 50 indicating a first direction and a second direction is displayed, with reference to a touch position P0 of the touch operation. The direction graphics 50 has a first direction graphics 51, a second direction graphics 52, and a circle graphics 53. The first direction graphics 51 is a graphics indicating a first direction in relation to the touch panel display 42. The second direction graphics 52 is a graphics indicating a second direction in relation to the touch panel display 42. According to the present embodiment, the first direction is set in a longitudinal direction of the touch panel display 42. In addition, the second direction is set to a direction perpendicular to the first direction. The first direction and the second direction may be arbitrarily set.

The circle graphics 53 indicates the first direction and the second direction with reference to the touch position P0. The circle graphics 53 is formed into a circle. The inside of the circle is equally divided into a number of parts that is twice the quantity of specific linear directions. In this case, the inside of the circle of the circle graphics 53 is equally divided into a number of parts that is a multiple of 2, that is, the quantity of the first direction and the second direction, or in other words, into four parts. The areas inside the circle graphics 53 that is divided into four equal parts are respectively set to a first area 531 indicating a positive (+) direction in the first direction, a second area 532 indicating a negative (−) direction in the first direction, a third area 533 indicating a positive (+) direction in the second direction, and a fourth area 534 indicating a negative (−) direction in the second direction.

In the direction graphics display process, the control unit 45 sets the touch position P0 by the touch operation to a center position P0 of the first direction graphics 51, the second direction graphics 52, and the circle graphics 53. The control unit 45 displays the first direction graphics 51, the second direction graphics 52, and the circle graphics 53 on the touch panel display 42 in a state in which the first direction graphics 51 and the second direction graphics 52 are perpendicular to each other, and the circle graphics 53 overlaps the first direction graphics 51 and the second direction graphics 52. According to the present embodiment, regarding the positive and negative directions in the first direction, the right side on the paper surface in relation to the center position P0 of the first direction graphics 51 is the positive (+) direction in the first direction, and the left side on the paper surface is the negative (−) direction in the first direction. In addition, regarding the positive and negative directions in the second direction, the upper side on the paper surface in relation to the center position P0 of the second direction graphics 52 is the positive (+) direction in the second direction, and the lower side on the paper surface is the negative (−) direction in the second direction

The drag operations in the first direction and the second direction are assigned arbitrary motion modes of the robot 20 or 30. According to the present embodiment, the drag operation in the first direction is assigned a motion mode of the end effector system in the X direction. In addition, the drag operation in the second direction is assigned a motion mode of the end effector system in the Y direction. The motion mode and motion direction of the robot 20 or 30 are determined by the operating direction immediately after the start of a drag operation performed subsequent to the touch operation detected at step S11.

In this case, the user can operate the robot 20 or 30 in the positive (+) direction in the motion mode in the X direction, by setting the operating direction immediately after the start of the drag operation to the (+) positive direction along the first direction graphics 51, that is, rightward on the paper surface in relation to the center position P0. In addition, the user can operate the robot 20 or 30 in the negative (−) direction in the motion mode in the X direction, by setting the operating direction immediately after the start of the drag operation to the (−) negative direction along the first direction graphics 51, that is, leftward on the paper surface in relation to the center position P0. Meanwhile, the user can operate the robot 20 or 30 in the positive (+) direction in the motion mode in the Y direction, by setting the operating direction immediately after the start of the drag operation to the (+) positive direction along the second direction graphics 52, that is, upward on the paper surface in relation to the center position P0. In addition, the user can operate the robot 20 or 30 in the negative (−) direction in the motion mode in the Y direction, by setting the operating direction immediately after the start of the drag operation to the (−) negative direction along the second direction graphics 52, that is, downward on the paper surface in relation to the center position P0.

Specifically, upon displaying the direction graphics 50 at step S12 in FIG. 4, at step S13, the control unit 45 determines whether or not a drag operation is performed subsequent to the touch operation detected at step S11. When determined that a drag operation is not detected (NO at step S13), the control unit 45 performs step S27 in FIG. 5. Meanwhile, when determined that a drag operation is detected (YES at step S13), the control unit 45 performs step S14. At step S14, the control unit 45 determines whether the operating direction immediately after the start of the drag operation is the first direction or the second direction.

The operating direction immediately after the start of a drag operation can be prescribed in the following manner, for example. That is, the operating direction immediately after the start of a drag operation can be a linear direction connecting the touch position P0 related to the touch operation detected at step S11, and a current position P1 of the finger 90 or the like when the current position P1 of the finger 90 or the like first becomes a position differing from the touch position P0 after the touch operation is detected at step S11. In addition, immediately after the start of a drag operation may include, for example, a period from when the operation detecting unit 46 detects a drag operation in the positive or negative direction in a specific linear direction, until the positive or negative direction of the drag operation is changed to the opposite direction.

When determined that the operating direction immediately after the start of the drag operation is the first direction (first direction at step S14), the control unit 45 performs steps S15 and S16. Meanwhile, when determined that the operating direction immediately after the start of the drag operation is the second direction (second direction at step S14), the control unit 45 performs steps S17 and S18. In the determination at step S14, positive/negative in the first direction or the second direction is not an issue.

At steps S15 and S17, the control unit 45 performs a motion mode determining process by a process performed by the motion command generating unit 47. The motion mode determining process is a process for determining the motion mode of the robot 20 or 30 to be a first motion mode when the operating direction immediately after the start of the drag operation is the first direction (first direction at step S14), and determining the motion mode of the robot 20 or 30 to be a second motion mode when the operating direction immediately after the start of the drag operation is the second direction (second direction at step S14).

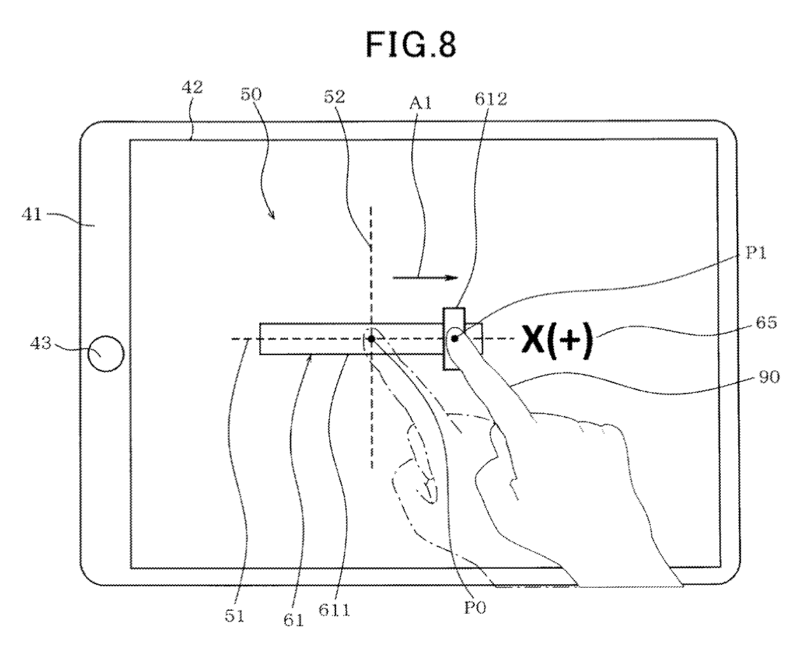

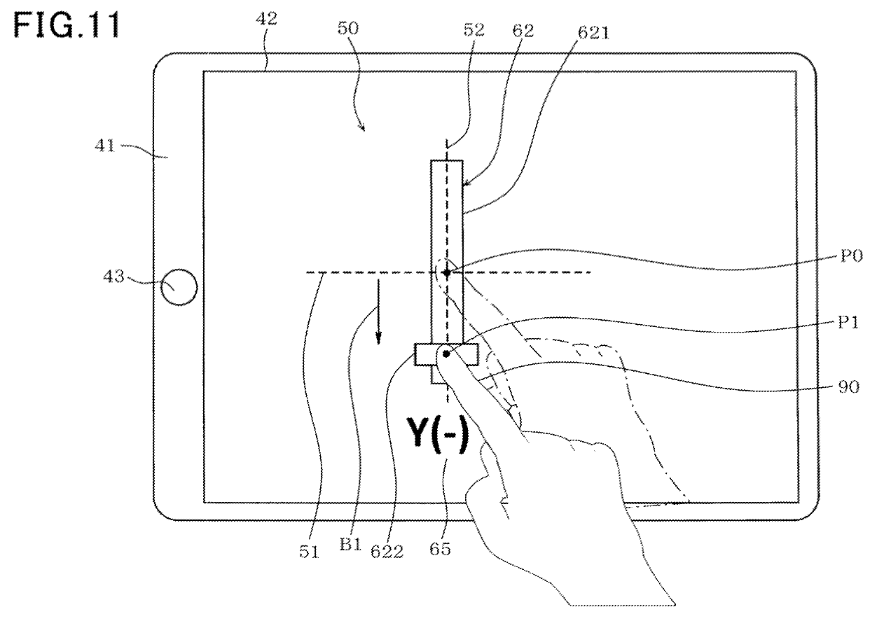

In this case, when the operating direction immediately after the start of the drag operation is a direction towards the first area 531 side or the second area 532 side in the circle graphics 53 shown in FIG. 7, that is, for example, the first direction along the first direction graphics 51 such as that indicated by an arrow Al in FIG. 8 (first direction at step S14), at step S15, the control unit 45 determines the motion mode of the robot 20 or 30 to be a motion of the end effector system in the X direction, which is the first motion mode. Meanwhile, when the operating direction immediately after the start of the drag operation is a direction towards the third area 533 side or the fourth area 534 side in the circle graphics 53, that is, for example, the second direction along the second direction graphics 52 such as that indicated by an arrow B1 in FIG. 11 (second direction at step S14), at step S17, the control unit 45 determines the motion mode of the robot 20 or 30 to be a motion of the end effector system in the Y direction, which is the second motion mode.

Next, at step S16 or S18, the control unit 45 performs an operation graphics display process by a process performed by the display control unit 48. The operation graphics display process is a process in which a first operation graphics 61 or a second operation graphics 62 is displayed on the touch panel display 43. In this case, when the operating direction immediately after the start of the drag operation is a direction towards the first area 531 side or the second area 532 side in the circle graphics 53, that is, the first direction along the first direction graphics 51 (first direction at step S14), as shown in FIG. 8, the control unit 45 displays the first operation graphics 61 that extends in the first direction on the touch display panel 42 (step S16). Meanwhile, when the operating direction immediately after the start of the drag operation is the second direction along the second direction graphics 52 (second direction at step S14), as shown in FIG. 11, the control unit 45 displays the second operation graphics 62 that extends in the second direction on the touch display panel 42 (step S18).

The first operation graphics 61 and the second operations graphics 62 are examples of operation graphics. The first operation graphics 61 is displayed overlapping the first direction graphics 51. The second operation graphics 62 is displayed overlapping the second direction graphics 52. In accompaniment with either one of the first operation graphics 61 and the second operations graphics 62 being displayed, the circle graphics 53 is deleted from the touch panel display 42.

The first operation graphics 61 and the second operations graphics 62 are graphics of which the aspects thereof change in accompaniment with the movement of the current position P1 of the drag operation. The first operation graphics 61 corresponds, for example, to the motion mode of the end effector system in the X direction. The second operation graphics 62 corresponds, for example, to the motion mode of the end effector system in the Y direction. The first operation graphics 61 and the second operations graphics 62 have similar basic configurations, excluding differences in the corresponding motion mode of the robot 20 or 30 and the direction in which the graphics is displayed.

As shown in FIG. 8, the first operation graphics 61 has a first bar 611 and a first slider 612. The first bar 611 is a graphics that is formed in a linear shape towards a specific linear direction that is, in this case, the first direction. In this case, the first bar 611 is formed into a laterally long, rectangular shape along the first direction, with a start position P0 of the drag operation as a base point. The first slider 612 is capable of moving along the first bar 611 in accompaniment with the drag operation. The first slider 612 is a graphics indicating the current position P1 of the drag operation on the first bar 61. That is, when the drag operation in the first direction is inputted, the display position of the first slider 612 moves in accompaniment with the movement of the current position P1 of the drag operation. The changes in the aspect of the first operation graphics 61 includes the changes in the relative positional relationship of the first slider 612 to the first bar 611. That is, the aspect of the first operation graphics 61 changes in accompaniment with the movement of the current position P1 resulting from the drag operation in the first direction.

In a similar manner, as shown in FIG. 11, the second operation graphics 62 has a second bar 621 and a second slider 622. The second bar 621 is a graphics that is formed in a linear shape towards a specific linear direction that is, in this case, the second direction. In this case, the second bar 621 is formed into a vertically long, rectangular shape along the second direction, with the start position P0 of the drag operation as a base point. The second slider 622 is capable of moving along the second bar 621 in accompaniment with the drag operation. The second slider 622 is a graphics indicating the current position P1 of the drag operation on the second bar 62. That is, when the drag operation in the second direction is inputted, the display position of the second slider 622 moves in accompaniment with the movement of the current position P1 of the drag operation. The changes in the aspect of the second operation graphics 62 includes the changes in the relative positional relationship of the second slider 622 to the second bar 621. That is, the aspect of the second operation graphics 62 changes in accompaniment with the movement of the current position P1 resulting from the drag operation in the second direction.

Next, the control unit 45 performs step S19 in FIG. 5. The control unit 45 determines whether the operating direction of the drag operation is the positive direction or the negative direction in the first direction or the second direction. Then, at step S20 or step S21, the control unit 45 performs a motion direction determining process by a process performed by the motion command generating unit 47. The motion direction determining process is a process in which the motion direction of the robot 20 or 30 is determined. The motion direction determining process includes a process in which the motion direction of the robot 20 or 30 is determined to be the positive direction when the operating direction immediately after the start of a drag operation is the positive direction in the first direction or the second direction, and the motion direction of the robot 20 or 30 is determined to be the negative direction when the operating direction immediately after the start of a drag operation is the negative direction in the first direction or the second direction.

For example, according to the present embodiment, when the operating direction of the drag operation is the first direction (in this case, the X direction) and the positive direction (first direction at step S14 and positive direction at step S19), the control unit determines the motion mode of the robot 20 or 30 to be the end effector system in the X direction, and the motion direction in the motion mode to be the positive direction. In addition, when the operating direction of the drag operation is the first direction (in this case, the X direction) and the negative direction (first direction at step S14 and negative direction at step S19), the control unit determines the motion mode of the robot 20 or 30 to be the end effector system in the X direction, and the motion direction in the motion mode to be the negative direction.

In a similar manner, when the operating direction of the drag operation is the second direction (in this case, the Y direction) and the positive direction (second direction at step S14 and positive direction at step S19), the control unit determines the motion mode of the robot 20 or 30 to be the end effector system in the Y direction, and the motion direction in the motion mode to be the positive direction. In addition, when the operating direction of the drag operation is the second direction (in this case, the Y direction) and the negative direction (second direction at step S14 and negative direction at step S19), the control unit determines the motion mode of the robot 20 or 30 to be the end effector system in the Y direction, and the motion direction in the motion mode to be the negative direction.

Next, at step S22, the control unit 45 measures an operating speed of the drag operation. Then, at step S23, the control unit performs a motion speed determining process. The motion speed determining process is a process in which a motion speed Vr at which to operate the robot 20 or 30 in the motion direction determined at step S20 or 21 is determined based on an absolute value |Vd| of an operating speed Vd of the drag operation measured at step S22.

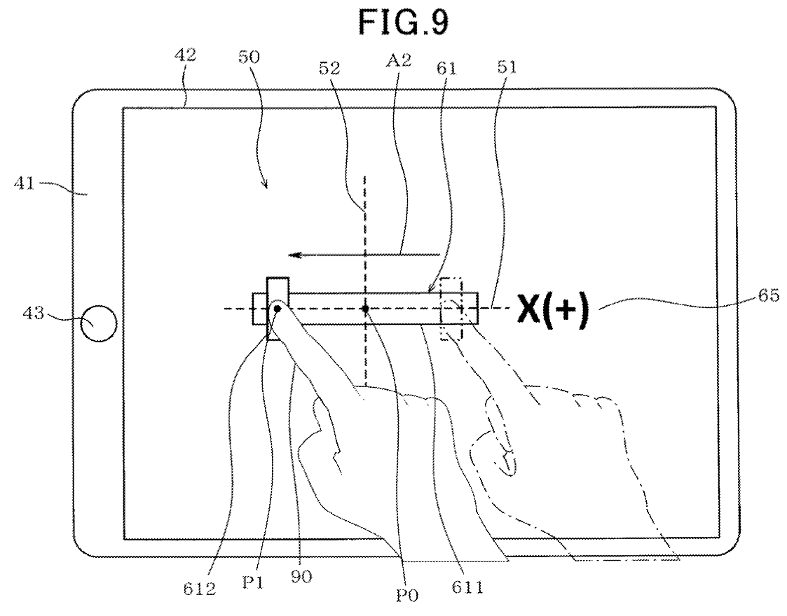

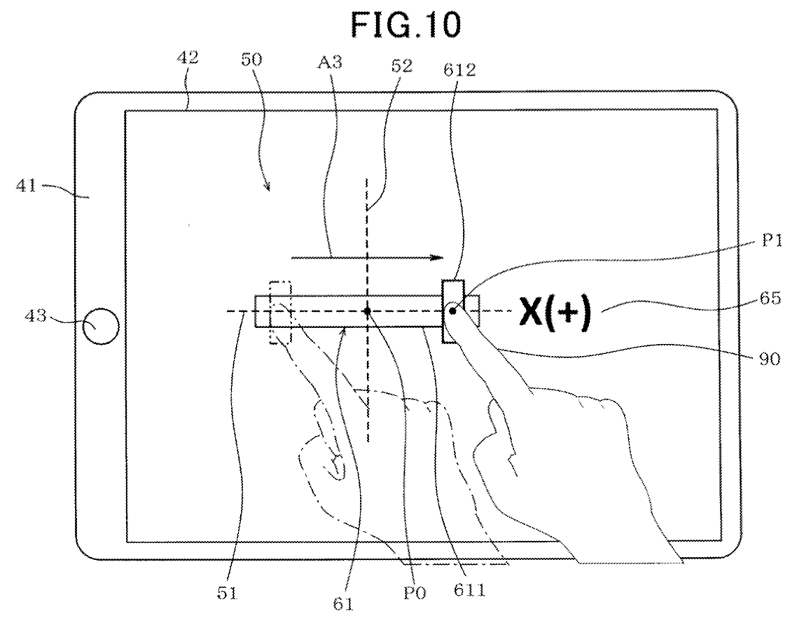

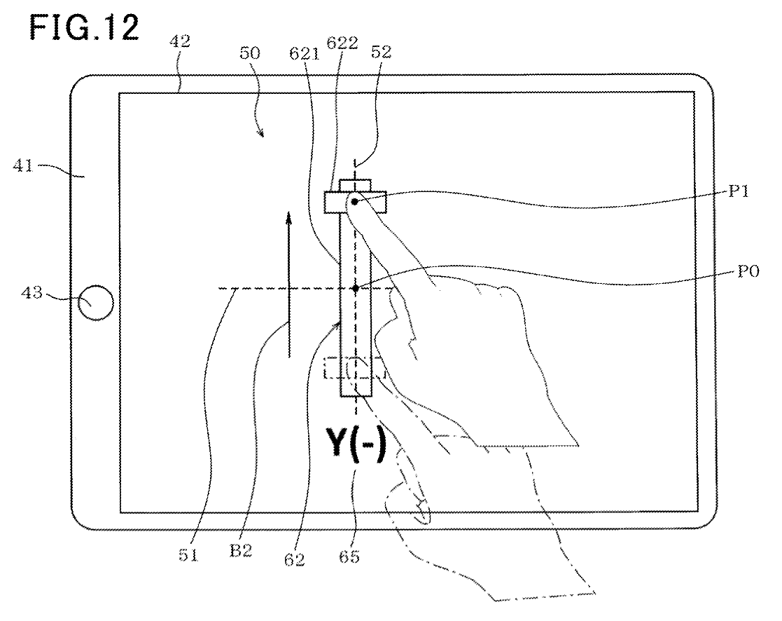

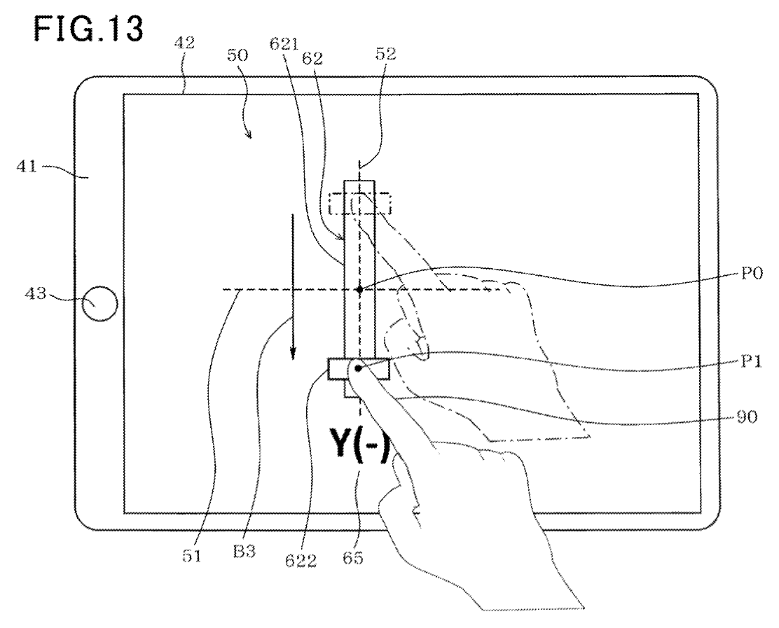

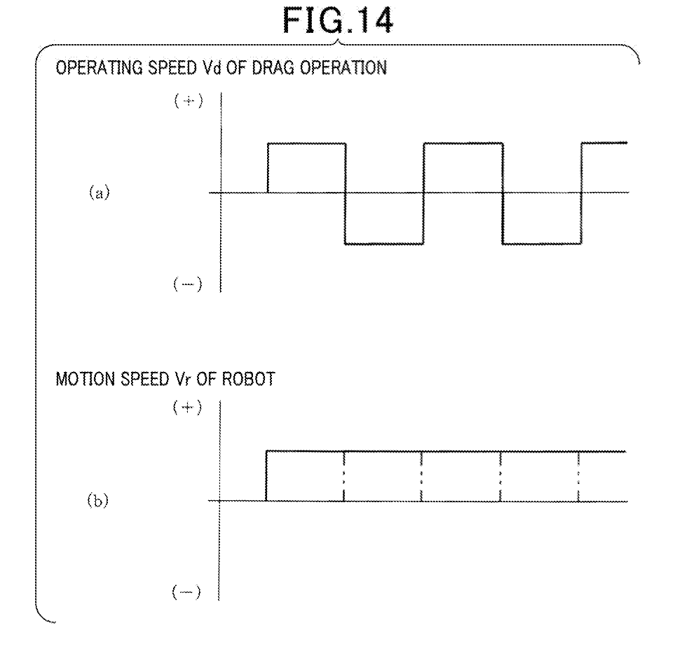

In this case, positive/negative of the operating direction of the drag operation is not taken into consideration in the determination of the motion speed Vr of the robot 20 or 30. That is, in the drag operation in the first direction or the second direction, the operating speed of the drag operation in the positive direction, that is, rightward on the paper surface is a positive (+) value. The operating speed of the drag operation in the negative direction, that is, leftward on the paper surface is a negative (−) value. Therefore, when a drag operation such as that in which the slider 612 or 622 is moved back and forth over the bar 611 or 621, such as a drag operation that repeats movement in the directions of arrows A2 and A3, as shown in FIG. 9 and FIG. 10, or a drag operation that repeats movement in the directions of arrows B2 and B3, as shown in FIG. 12 and FIG. 13, is performed, the operating speed Vd of the drag operation repeatedly becomes a positive value and a negative value in an alternating manner, as shown in FIG. 14(a). As shown in FIG. 14(b), the control unit 45 determines the motion speed Vr of the robot 20 or 30 based on the absolute value |Vd| of the operating speed Vd of the drag operation in which positive and negative values alternately appear.

Next, at step S24, the control unit 45 performs a motion command generating process. The control unit 45 generates a motion command to make the the robot 20 or 30 operate based on the motion mode of the robot 20 or 30 determined in the motion mode determining process (step S15 or S17), the motion direction of the robot 20 or 30 determined in the motion direction determining process (step S20 or 21), and the motion speed Vr of the robot 20 or 30 determined in the motion speed determining process (step S23). Then, at step S25, the control unit 45 transmits the motion command generated at step S24 to the controller 11. The controller 11 operates the robot 20 or 30 based on the motion command received from the teaching pendant 40.

Next, at step S26, the control unit 45 performs the operation graphics display process. The control unit 45 changes the aspect of the first operation graphics 61 displayed at step S16 or the second operation graphics 62 displayed at step S18 based on the current position P1 of the drag operation, and displays the first operation graphics 61 or the second operation graphics 62. In this case, when the first operation graphics 61 is displayed on the touch panel display 42 by step S16 being performed, the control unit 45 moves the first slider 612 of the first operation graphics 61 based on the current position P1 of the drag operation. In addition, when the second operation graphics 62 is displayed on the touch panel display 42 by step S18 being performed, the control unit 45 moves the second slider 622 of the second operation graphics 62 based on the current position P1 of the drag operation. As a result, the slider 612 or 622 of the operation graphics 61 or 62 displayed on the touch panel display 42 moves such as to track the drag operation.

In addition, according to the present embodiment, as shown in FIG. 8 or FIG. 11, the control unit 45 displays an operating display 65 on the touch panel display 42 by a process performed by the display control unit 48. The operating display 65 displays the motion mode and motion direction of the robot 20 or 30 that is currently set. That is, the operating display 65 indicates the motion mode determined at step S15 or S17 and the motion direction determined at step S20 or S21.

Next, the control unit 45 performs step S27. The control unit 45 determines whether or not the operation is completed, based on a detection result from the operation detecting unit 46. In this case, the completion of an operation refers to the finger 90 of the user or the like separating from the touch panel display 42. That is, the operation is not determined to be completed merely by the operating speed of the drag operation becoming zero.

When the drag operation is continued (NO at step S27), the control unit 45 proceeds to step S22 and repeatedly performs steps S22 to S27. The processes at steps S22 to S27 are repeatedly performed every 0.5 seconds, for example. Therefore, no significant time delay occurs between the input of the drag operation, the motion of the robot 20 or 30, and the movement of the slider 612 or 622. Consequently, the user can receive the impression that the robot 20 or 30 is being manually operated substantially in real-time.

In addition, after the motion aspect is determined at step S15 or S17 and the motion direction is determined at step S20 or S21, the user can make the robot 20 or 30 continue operating in the determined motion mode and motion direction by continuing the drag operation in the back-and-forth direction, such as that shown in FIG. 9 and FIG. 10 or FIG. 12 and FIG. 13. Then, when determined that the drag operation is completed based on the detection result from the operation detecting unit 46 (YES at step S27), the control unit 45 performs steps S28 and S29.

At step S28, the control unit 45 cancels, or in other words, resets the settings of the motion mode and the motion direction of the robot 20 or 30 determined in the above-described processes. As a result, the operation of the robot 20 or 30 is completed. At step S29, the control unit 45 deletes the direction graphics 50 and the operation graphics 61 or 62 from the touch panel display 42 by a process performed by the display control unit 48, and resets the display content on the screen. As a result, the series of processes is completed. Then, the control unit 45 returns to step S11 in FIG. 4 and performs the processes at steps S11 to S29 again. As a result, the user is able to perform manual operation in a new motion mode and motion direction. That is, the user is able to change the motion mode and motion direction of the robot 20 or 30.

According to the present embodiment, the control unit 45 can perform the motion direction determining process and the motion speed determining process by the processes performed by the motion command generating unit 47. The motion direction determining process is a process in which the motion direction of the robot 20 or 30 is determined. The motion speed determining process is a process in which, when the operation detecting unit 46 detects a drag operation in a specific linear direction that is, in this case, the positive or negative direction in the first direction or the second direction, after the motion direction determining process is performed, the motion speed Vr for operating the robot 20 or 30 in the motion direction determined in the motion direction determining process is determined based on the absolute value |Vd| of the operating speed Vd of the drag operation.

That is, in the above-described configuration, when the motion direction of the robot 20 or 30 is determined and the drag operation in the positive or negative direction in the first direction or the second direction is performed on the touch panel display 42, the motion speed Vr of the robot 20 or 30 is determined based on the absolute value |Vd| of the operating speed Vd of the drag operation. That is, in the drag operation performed to determine the operating speed Vr of the robot 20 or 30, the positive/negative direction of the drag operation does not affect the motion direction of the robot 20 or 30. Therefore, the user can continue to make the robot 20 or 30 operate at the motion speed Vr corresponding to the operating speed Vd of the drag operation by performing the drag operation such as to move back and forth in a linear manner in the first direction or the second direction on the touch panel display 42, that is, such as to rub the touch panel display 42 with the finger 90 or the like.

For example, when the user continues to perform the drag operation such as to move back and forth in the first direction or the second direction at a high operating speed Vd, that is, when the user continues to rub the touch panel display 42 with the finger 90 or the like at a high speed, the robot 20 or 30 continues to operate at a high motion speed Vr corresponding to the high operating speed Vd. Meanwhile, when the user continues to perform the drag operation such as to move back and forth in the first direction or the second direction at a low speed, that is, when the user continues to rub the touch panel with the finger 90 or the like at a low speed, the robot 20 or 30 continues to operate at a low motion speed Vr corresponding to the low operating speed Vd. When the user stops the drag operation, the robot 20 or 30 also stops.

In this way, in the teaching pendant 40 according to the present embodiment, the user can make the robot 20 or 30 continue operating by continuously moving their own finger 90 or the like. The user can make the robot 20 or 30 stop by stopping their finger or the like. In addition, the user can adjust the motion speed Vr of the robot 20 or 30 by adjusting the movement speed Vd of their own finger 90 or the like. As a result, the user easily receives the impression that the movement of the finger 90 or the like resulting from their own drag operation and the motion of the robot 20 or 30 are correlated. Therefore, the user can intuitively determine the correlation between the drag operation performed by the user themselves and the motion of the robot 20 or 30 performed as a result of the drag operation. As a result, user operability can be improved.

Furthermore, in the teaching pendant 40 according to the present embodiment, the user can make the robot 20 or 30 continue operating by continuously performing the drag operation such as to move back and forth on the touch panel display 42. Therefore, the user can continue the drag operation for making the robot 20 or 30 operate without being restricted by the screen size of the touch panel display 42. Consequently, a situation in which the operation of the robot 20 or 30 is unintentionally stopped or the like as a result of the drag operation not being able to be continued due to restriction by the screen size of the touch panel display 42 can be prevented. As a result, operability is improved. In addition, continuation of the drag operation to make the robot 20 or 30 operate is not restricted by the screen size of the touch panel display 42. Therefore, the touch panel display 42 can be reduced in size. For example, even when the teaching pendant 40 is configured by a wristwatch-type wearable terminal that can be attached to the arm of the user, the user can appropriately perform manual operation of the robot 20 or 30 with the small screen of the wearable terminal.

In addition, in the teaching pendant 40 according to the present embodiment, motion distance of the robot 20 or 30 is obtained by the motion speed Vr of the robot 20 or 30 being multiplied by the amount of time over which the drag operation is performed, that is, the operating time. In addition, the motion speed Vr of the robot 20 or 30 is correlated with the operating speed of the drag operation. That is, the motion distance of the robot 20 or 30 is correlated with a value obtained by the operating speed Vd of the drag operation being multiplied by the operating time of the drag operation, or in other words, movement distance of the finger or the like by the drag operation. In this case, for example, the motion distance of the robot 20 or 30 becomes short when the movement distance of the finger or the like by the drag operation is short. The motion distance of the robot 20 or 30 becomes long when the movement distance of the finger or the like by the drag operation is long. That is, the user can shorten the motion distance of the robot 20 or 30 by shortening the movement distance of the finger or the like by, for example, performing a drag operation in which the finger or the like is moved back and forth in small motions. In addition, the user can lengthen the motion distance of the robot 20 or 30 by lengthening the movement distance of the finger or the like by, for example, performing a drag operation in which the finger or the like is moved back and forth in large motions.

In this way, in the teaching pendant 4 according to the present embodiment, the user can adjust the motion distance of the robot 20 or 30 by adjusting the movement distance of the finger or the like in their drag operation. As a result, the user easily receives the impression that the movement distance of the finger or the like in their drag operation is reflected in the motion distance of the robot 20 or 30. That is, the user can directly and intuitively determine the correlation between the drag operation performed by the user themselves and the motion of the robot 20 or 30 performed as a result of the drag operation. As a result, user operability can be improved.

The motion direction determining process includes a process in which the motion direction of the robot 20 or 30 is determined to be the positive direction when the operating direction immediately after the start of a drag operation is the positive direction in the first direction or the second direction, and the motion direction of the robot 20 or 30 is determined to be the negative direction when the operating direction immediately after the start of a drag operation is the negative direction in the first direction or the second direction. That is, the motion direction of the robot 20 or 30 is determined by the operating direction immediately after the start of the drag operation. In addition, the motion speed Vr of the robot 20 or 30 is determined by the absolute value |Vd| of the operating speed Vd of the drag operation that is subsequently continuously performed. Consequently, the user is not required to perform a separate operation to determine the motion direction of the robot 20 or 30. The user can perform both the operation to determine the motion direction of the robot 20 or 30 and the operation to determine the motion speed Vr by a series of drag operations. As a result, the hassle of performing operations can be reduced and operability is improved.

In addition, the control unit 45 is capable of performing the motion mode determining process by the processes performed by the motion command generating unit 47. The motion mode determining process is a process in which the motion mode of the robot 20 or 30 is determined to be the first motion mode when the operating direction of the drag operation determined by the operation detecting unit 46 is the first direction, and the motion mode of the robot 20 or 30 is determined to be the second motion mode when the operating direction of the drag operation determined by the operation detecting unit 46 is the second direction. Consequently, the user can perform manual operation regarding two motion modes of the robot 20 or 30 by selectively using the drag operations in the first direction and the second direction. Therefore, an operation for selecting the motion mode of the robot 20 or 30 can be eliminated. As a result, the hassle of performing operations is reduced and operability is improved.

In addition, the first direction and the second direction are perpendicular to each other. In this case, the angle formed by the first direction and the second direction is a right angle, which is the largest angle within the range of angles that can be formed by the first direction and the second direction. Therefore, the user can easily perform operations while differentiating between the drag operation in the first direction and the drag operation in the second direction. Consequently, situations in which the user performs an operation in which the operating direction of the drag operation is erroneous, or the drag operation is in a direction unintended by the user can be reduced. As a result, erroneous operation of the drag operation is reduced, and further improvement in operability and improvement in safety are achieved.

The teaching pendant 40 further includes the touch panel display 42 that is capable of displaying graphics, and the display control unit 48 that controls the display content of the touch panel display 42. The control unit 45 is capable of performing the direction graphics display process by the processes performed by the display control unit 48. The direction graphics display process is a process in which, when the operation detecting unit 46 detects a touch operation, the direction graphics 50 that indicates the first direction and the second direction with reference to the touch position P0 of the touch operation is displayed on the touch panel display 42. Consequently, when the user performs a touch operation on the touch panel display 42 to perform a drag operation, the direction graphics 50 indicating the first direction and the second direction is displayed on the touch panel display 42. The first direction and the second direction are the operating directions of a drag operation performed when the motion speed Vr of the robot 20 or 30 is determined. Therefore, the user can more easily determine the direction in which to perform the drag operation by viewing the direction graphics 50 on the touch panel display 42 before starting the drag operation. As a result, operability is further improved.

The control unit 45 is capable of performing the operation graphics display process by the processes performed by the display control unit 48. The operation graphics display process is a process in which, when the operation detecting unit 46 detects a drag operation in the first direction or the second direction, the operation graphics 61 or 62 that changes in aspect in accompaniment with the movement of the current position P1 of the drag operation is displayed on the touch panel display 42. Consequently, the user can visually determine whether or not their drag operation is being appropriately performed by viewing the operation graphics 61 or 62 that changes in accompaniment with the movement of the finger 90 or the like, that is, the current position P1 of their drag operation. As a result, intuitive operation becomes possible, the sense of operation felt by the user can be improved, and operability can be improved.

In addition, as a result of the robot operation program according to the present embodiment being run on, for example, a general-purpose tablet PC, a smartphone, or the like that is provided with a touch panel display, functions equivalent to those of the above-described teaching pendant 40 can be added to the general-purpose tablet PC, smartphone, or the like.

In addition, according to the present embodiment, the user can operate the robot 20 or 30 by performing touch operations and drag operations on the touch panel display 42. Consequently, compared to when physical operating keys are operated, the user can more intuitively and more easily perform manual operation. Furthermore, consequently, physical operating keys for manual operation, for example, can be eliminated. As a result, effects can be expected such as actualization of reduced size of the teaching pendant 40, increased screen size of the touch panel display 42, and reduced cost.

The circle graphics 53 of the direction graphics 50, shown in FIG. 7, is not limited to a circle and may be, for example, a polygon. In addition, according to the present embodiment, the direction graphics 50 is merely required to have at least either of the circle graphics 53, and the first direction graphics 51 and the second direction graphics 52. As a result of at least either of the circle graphics 53, and the first direction graphics 51 and the second direction graphics 52 being displayed on the touch panel display 42, the user can be presented with the first direction and the second direction. Therefore, according to the present embodiment, either of the circle graphics 53, and the first direction graphics 51 and the second direction graphics 52 can be omitted and not displayed.

### Second Embodiment

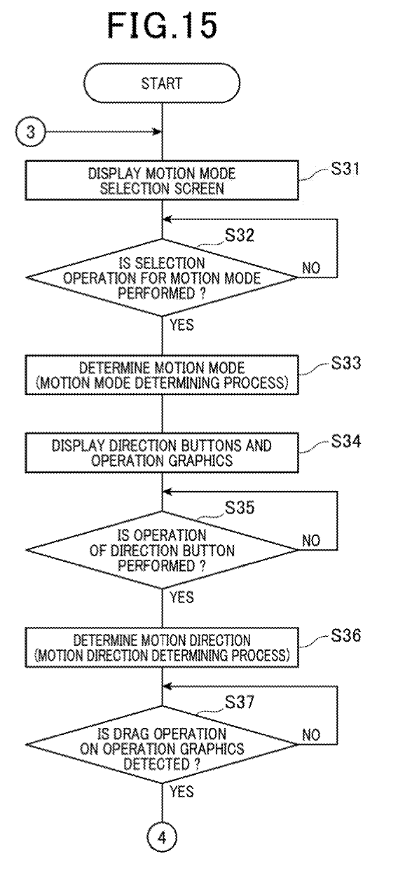

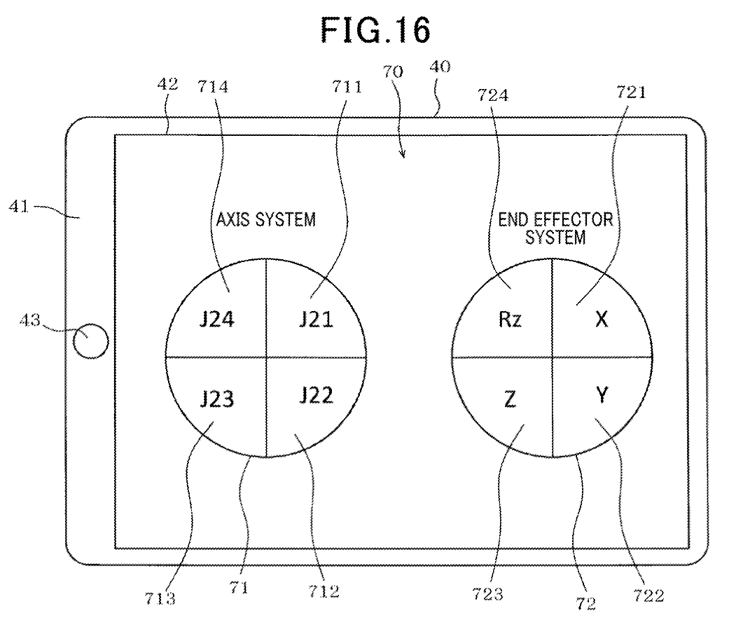

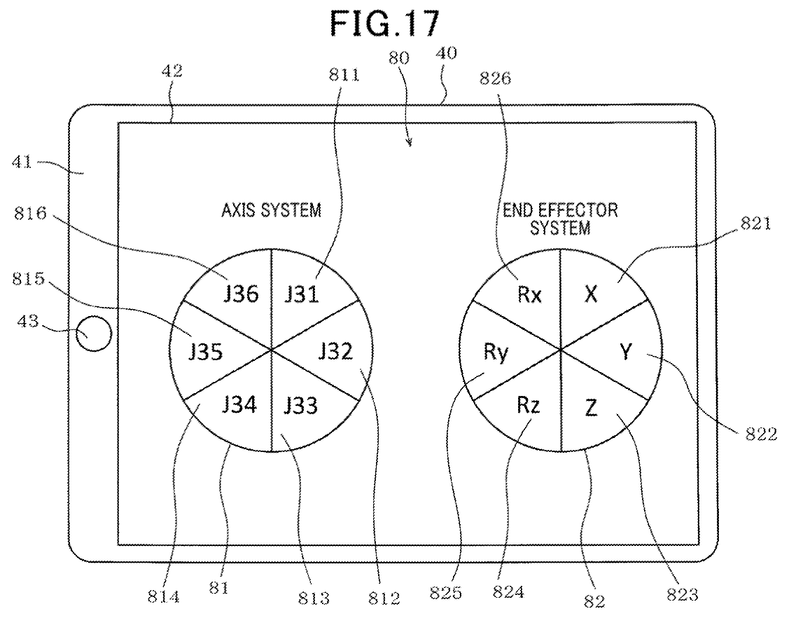

Next, a second embodiment will be described with reference to FIG. 15 to FIG. 20. According to the present embodiment, the control unit 45 can determine the motion mode and motion direction of the robot 20 or 30 by a method differing from the drag operation. That is, according to the present embodiment, the specific details of the motion mode determining process at steps S15 and S17 in FIG. 4 and the motion direction determining process at steps S20 and S21 in FIG. 5 differ from those according to the above-described first embodiment. In other words, when manual operation is started and step S31 in FIG. 15 is performed, the control unit 45 displays a motion mode selection screen 70 or 80, shown in FIG. 16 or FIG. 17, on the touch panel display 42 by processes performed by the display control unit 48. The motion mode selection screen 70 or 80 is used by the user to select the motion mode of the robot 20 or 30 by a touch operation.

For example, the motion mode selection screen 70 shown in FIG. 16 is for the four-axis robot 20. The motion mode selection screen 70 has a selection portion 71 for the axis system and a selection portion 72 for the end effector system. The outer shapes of the selection portions 71 and 72 are formed into circles. The inside of the circle of each of the selection portions 71 and 72 is equally divided into the number of drive modes of each motion system. In the case of the motion mode selection screen 70 for the four-axis robot, the inside of the circle of each of the selection portions 71 and 72 is equally divided into four parts, which amounts to the number of drive modes of each motion system of the four-axis robot 20. The areas inside the selection portions 71 and 72 that are each equally divided into four parts are respectively set to selection areas 711 to 714 for the axis system and selection areas 721 to 724 for the end effector system.

In this case, in the selection portion 71 for the axis system, the selection area 711 is assigned to the motion mode of the first axis J21. The selection area 712 is assigned to the motion mode of the second axis J22. The selection area 713 is assigned to the motion mode of the third axis J23. The selection area 714 is assigned to the motion mode of the fourth axis J24. In addition, in the selection portion 72 for the end effector system, the selection area 721 is assigned to the motion mode in the X direction. The selection area 722 is assigned to the motion mode in the Y direction. The selection area 723 is assigned to the motion mode in the Z direction. The selection area 724 is assigned to the motion mode in the Rz direction. As a result, the user can perform a touch operation on any of the areas among the selection areas 711 to 714 and 721 to 724, and thereby operate the robot 20 in the motion mode assigned to the area.

In addition, for example, the motion mode selection screen 80 shown in FIG. 17 is for the six-axis robot. The motion mode selection screen 80 has a selection portion 81 for the axis system and a selection portion 82 for the end effector system. The outer shapes of the selection portions 81 and 82 are formed into circles. The inside of the circle of each of the selection portions 81 and 82 is equally divided into the number of drive modes of each motion system. In the case of the motion mode selection screen 80 for the six-axis robot, the inside of the circle of each of the selection portions 81 and 82 is equally divided into six parts, which amounts to the number of drive modes of each motion system of the six-axis robot 30. The areas inside the selection portions 81 and 82 that are each equally divided into six parts are respectively set to selection areas 811 to 816 for the axis system and selection areas 821 to 826 for the end effector system.

In this case, in the selection portion 81 for the axis system, the selection area 811 is assigned to the motion mode of the first axis J31. The selection area 812 is assigned to the motion mode of the second axis J32. The selection area 813 is assigned to the motion mode of the third axis J33. The selection area 814 is assigned to the motion mode of the fourth axis J34. The selection area 815 is assigned to the motion mode of the fifth axis J35. The selection area 816 is assigned to the motion mode of the sixth axis J36. In addition, in the selection portion 82 for the end effector system, the selection area 821 is assigned to the motion mode in the X direction. The selection area 822 is assigned to the motion mode in the Y direction. The selection area 823 is assigned to the motion mode in the Z direction. The selection area 824 is assigned to the motion mode in the Rz direction. The selection area 825 is assigned to the motion mode in the Ry direction. The selection area 826 is assigned to the motion mode in the Rx direction. As a result, the user can perform a touch operation on any of the areas among the selection areas 811 to 816 and 821 to 826, and thereby operate the robot 30 in the motion mode assigned to the area.

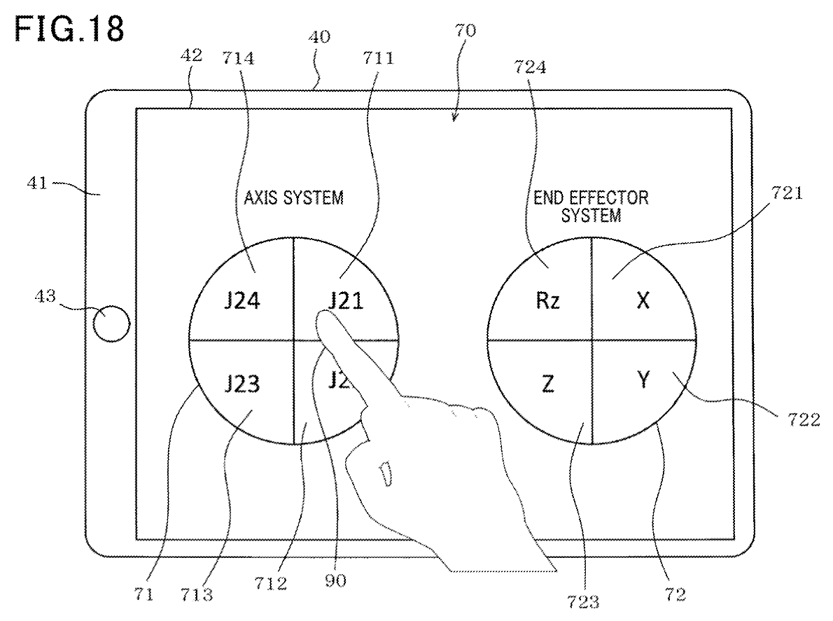

At step S32 in FIG. 15, the control unit 45 determines whether or not an operation is performed on any of the selection areas 711 to 714 and 721 to 724 or any of the selection areas 811 to 8116 and 821 to 826, based on a detection result from the operation detecting unit 46. When determined that a touch operation is not performed on any of the selection areas (NO at step S32), the control unit 45 waits while maintaining the display of the motion mode selection screen 70 or 80. Meanwhile, when determined that a touch operation is performed on any of the selection areas (YES at step S32), the control unit 45 proceeds to step S33. Then, when step S33 is performed, the control unit 45 determines the motion mode of the robot 20 or 30 in manual operation to be the motion mode selected at step S32, by processes performed by the motion command generating unit 47. For example, as shown in FIG. 18, when the user performs a touch operation on the selection area 711 of the selection portion 71 for the axis system on the motion mode selection screen 70 for the four-axis robot 20, the control unit 45 determines the motion mode of the robot 20 to be the motion mode in which the first axis J21 of the axis systems is driven.

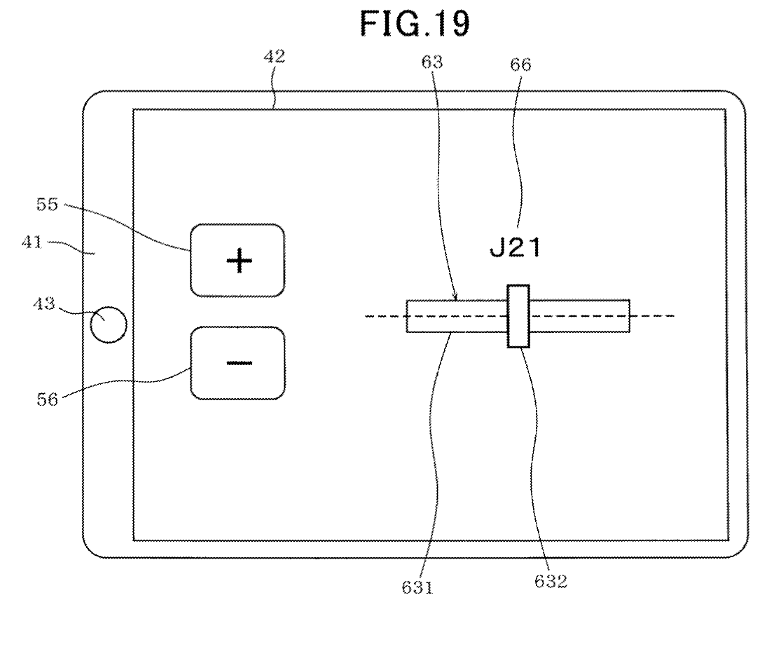

Next, the control unit 45 performs step S34 in FIG. 15. The control unit 45 displays a third operation graphics 63, an operating display 66, a positive-direction button 55, and a negative-direction button 56 on the touch panel display 42, as shown in FIG. 19, by processes performed by the display control unit 48. The third operation graphics 63 has a configuration similar to those of the first operation graphics 61 and the second operation graphics 62. The third operation graphics 63 has a third bar 631 and a third slider 632. In this case, in a manner similar to the first operation graphics 61, the third operation graphics 63 is disposed such as to be laterally long in relation to the touch panel display 42. However, the third operation graphics 63 is not limited thereto, and may be disposed such as to be vertically long in relation to the touch panel display 42 in a manner similar to the second operation graphics 62, or may be disposed in other forms.

In addition, in a manner similar to the operating display 65 according to the first embodiment, the operating display 66 indicates the motion mode and the motion direction of the robot 20 or 30. The operating display 66 shown in FIG. 19 indicates a state in which the motion mode of the robot 20 or 30 is determined to the mode in which the first axis J21 is driven, but the motion direction is not yet determined. In this case, the operating display 66 displays “J21” that indicates driving of the first axis J21 of the axis systems.

The positive-direction button 55 corresponds to motion of the robot 20 or 30 in the positive direction. The negative-direction button 56 corresponds to motion of the robot 20 or 30 in the negative direction. By moving the third slider 632 back and forth along the third bar 631 while touch-operating the positive-direction button 55, the user can make the robot 20 or 30 operate in the positive direction in the motion mode determined at step S33. In addition, by moving the third slider 632 back and forth along the third bar 631 while touch-operating the negative-direction button 56, the user can make the robot 20 or 30 operate in the negative direction in the motion mode determined at step S33.

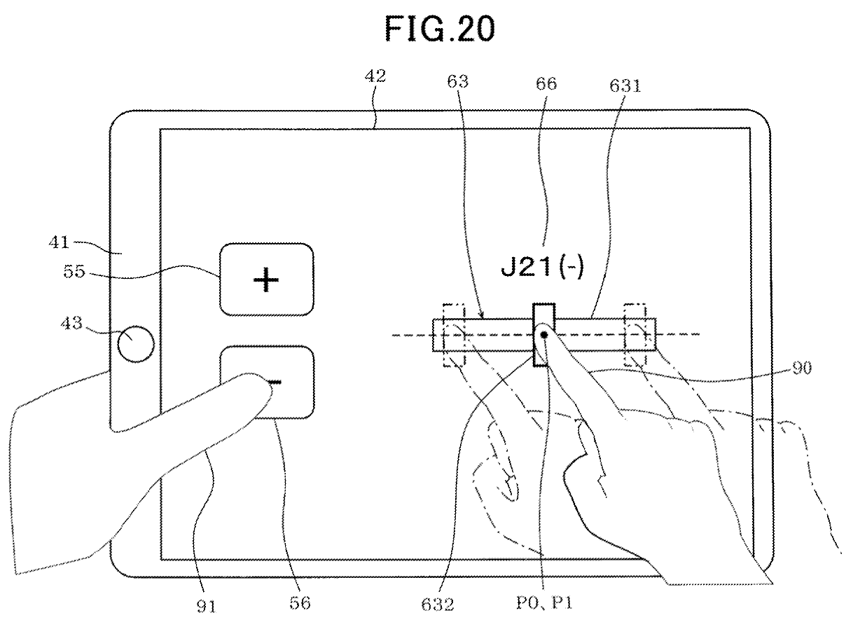

That is, at step S35, the control unit 45 determines whether or not a touch operation is performed on the direction button 55 or 56 based on a detection result from the operation detecting unit 46. When determined that a touch operation is not performed (NO at step S35), the control unit 45 waits in the state in FIG. 19. Meanwhile, when a touch operation is performed on either of the positive-direction button 55 and the negative-direction button 56, as shown in FIG. 20, for example, the control unit 45 determines that a touch operation is performed (YES at step S35) and performs step S36.

At step S26, the control unit 45 performs the motion direction determining process. When the positive-direction button 55 is touch-operated, the control unit 45 determines the motion direction of the robot 20 or 30 to be the positive direction. When the negative-direction button 56 is touch-operated, the control unit 45 determines the motion direction of the robot 20 or 30 to be the negative direction. For example, when the negative-direction button 56 is touch-operated in a state in which the motion mode of the first axis J21 of the axis systems is selected, as shown in FIG. 20, the operating display 66 becomes that in which “(−)” indicating motion in the negative direction is added to “J21” indicating the motion mode of the first axis J21 of the axis systems. In addition, although details are not shown, when the positive-direction button 55 is touch-operated in a state in which the motion mode of the first axis J21 of the axis systems is selected, the operating display 66 becomes that in which “(+)” indicating motion in the positive direction is added to “J21” indicating the motion mode of the first axis J21 of the axis systems.

Subsequently, at step S37, the control unit 45 determines whether or not a drag operation of the third slider 632 of the third operation graphics 63 is performed. When determined that a drag operation of the third slider 632 is not detected (NO at step S37), the control unit 45 waits until a drag operation is performed. Then, when determined that the drag operation of the third slider 632 is detected (YES at step S37), the control unit 45 performs processes at step S22 and subsequent steps in FIG. 5. As a result, the user can make the robot 20 or 30 continue to operate in the motion mode and the motion direction selected by the user, by continuing the drag operation on the third operation graphics 63.

Consequently, the user can perform manual operation while switching among three or more motion modes. Therefore, improvement in operability from a perspective differing from that according to the above-described first embodiment can be achieved. In addition, the selection portions 71, 72, 81, and 82 are each formed into a circle. The inside of the circle is equally divided based on the number of motion modes of the robot 20 or 30. Each area inside the equally divided circle is assigned a motion mode of the robot 20 or 30. Consequently, the user can easily recognize which motion mode is assigned to which selection area. As a result, operability can be further improved.

### Third Embodiment

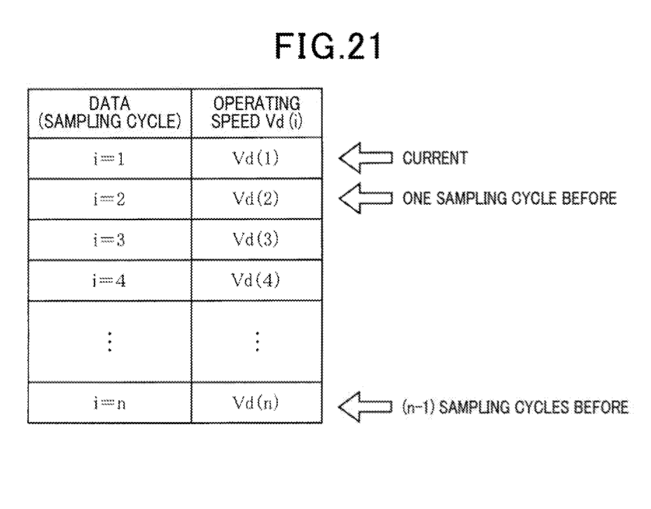

Next, a third embodiment will be described with reference also to FIG. 21 to FIG. 23. The robot system 10 according to the present embodiment is characteristic in terms of the method for determining the motion speed Vr of the robot 20 or 30 in the motion speed determining process. That is, the following issue arises when the motion speed Vr of the robot 20 or 30 is merely a value that is simply proportional to the absolute value |Vd| of the operating speed Vd of the drag operation. In this case, for example, when the user inputs an unintended, sudden drag operation, the sudden drag operation is directly reflected in the motion speed Vr of the robot 20 or 30. As a result, the robot 20 or 30 may operate in a mode unintended by the user. Therefore, according to the present embodiment, the motion speed determining process includes a process in which the absolute value |Vd| of the operating speed Vd of the drag operation inputted by the user is corrected by a predetermined method, and the motion speed Vr of the robot 20 or 30 is determined based on a correction value Vdx.

Specifically, the control unit 45 stores the operating speed Vd of the drag operation in the storage area 452, shown in FIG. 3, at a fixed sampling cycle. According to the present embodiment, the sampling cycle is set to several to several tens of milliseconds. The storage area 452 is capable of storing therein data on an n-number of operating speeds Vd, for example. FIG. 21 shows the data on the operating speeds Vd stored in the storage area 452 at a certain time. The storage area 452 stores therein data on the n-number of operating speeds Vd over previous predetermined sampling cycles.

In this case, as shown in FIG. 21, the operating speed Vd that had been stored i sampling cycles before the current sampling cycle is Vd(i). That is, i in FIG. 21 is an arbitrary positive integer that indicates oldness/newness of the data on the operating speed Vd stored in the storage unit 452. In other words, i being a greater value indicates that the operating speed Vd(i) had been acquired at an earlier period, and i being a smaller value indicates that the operating speed Vd(i) had been acquired at a more recent period. In this case, the data on the operating speed Vd(1) when i=1 is the newest among the operating speeds Vd(i) stored in the storage area 452.

The control unit 45 stores the data on the operating speeds Vd(i) in a so-called first-in first-out format. That is, upon acquiring the newest operating speed Vd(i), the control unit 45 stores the newest operating speed Vd(i) in the storage area 452 as the operating speed Vd(1). Then, the control unit 45 moves down Vd(1), Vd(2), . . . of the one sampling cycle before to |Vd(2)|, |Vd(3)|, . . . and stores the operating speeds in the storage area 452 In this way, the control unit 45 updates the data on the operating speeds Vd(i) stored in the storage area 452 at each sampling cycle.

Here, the current operating speed Vd(1) is a first operating speed, and an operating speed Vd(2) of a predetermined sampling cycle before the current sampling cycle, such as one sampling cycle before, is a second operating speed. The second sampling speed does not have to be that of a sampling cycle adjacent to the first operating speed, that is, continuous with the first operating speed. In other words, for example, the second operating speed may be an operating speed Vd(i) that is several sampling cycles apart from the first operating speed.

The motion speed determining process includes a process in which the correction value Vdx that is the corrected absolute value |Vd| of the operating speed Vd of the drag operation is calculated, and the motion speed Vr is determined based on the correction value Vdx. The correction value Vdx is calculated based on an absolute value |Vd(1)| of the first operating speed Vd(1) and an absolute value |Vd(2)| of the second operating speed Vd(2). Specifically, as shown in following expression (1), in the motion speed determining process, the correction value Vdx is set to zero when the absolute value |Vd(1)| of the first operating speed Vd(1) is less than ½ of the absolute value |Vd(2)| of the second operating speed Vd(2).

[Formula 1]

0≦Vd(1)|<|Vd(2)|/2 (1)

In addition, in the motion speed determining process, the correction value Vdx is calculated based on following expression (3) when the absolute value |Vd(1)| of the first operating speed Vd(1) is equal to or greater than ½ of the absolute value |Vd(2)| of the second operating speed Vd(2), as indicated in following expression (2). In this case, the correction value Vdx is a value obtained by the absolute value of the difference between the absolute value |Vd(1)| of the first operating speed Vd(1) and the absolute value |Vd(2)| of the second operating speed Vd(2) being subtracted from the absolute value |Vd(1)| of the first operating speed Vd(1).

[Formula 2]

|Vd(1)|≧|Vd(2)|/2 (2)

[Formula 3]

Vdx=|Vd(1)|−∥Vd(1)|−|Vd(2)∥ (3)

That is, when the motion speed determining process is performed at step S23 in FIG. 5, the control unit 45 calculates the correction value Vdx that is corrected based on the above-described expressions (1) to (3). Then, the control unit 45 determines the motion speed Vr of the robot 20 or 30 to be of a magnitude based on the correction value Vdx, such as a value obtained by the correction value Vdx being multiplied by a predetermined coefficient.

Here, the following three magnitude relationships between the absolute value |Vd(1)| of the first operating speed Vd(1) and the absolute value |Vd(2)| of the second operating speed Vd(2) can be considered, that is, |Vd(1)|>|Vd(2)|: condition (1); |Vd(1)|=|Vd(2)|: condition (2); and |Vd(1)|<|Vd(2)|: condition (3).

In addition, the absolute value |Vd(2)| of the second operating speed Vd(2) indicates the absolute value |Vd| of the operating speed Vd of the drag operation performed a predetermined sampling cycle before, that is, immediately before, the current sampling cycle. Therefore, as indicated by the above-described condition (1), the absolute value |Vd(1)| of the first operating speed Vd(1) being greater than the absolute value |Vd(2)| of the second operating speed Vd(2) means that the absolute value |Vd| of the operating speed Vd of the drag operation is increasing, or in other words, that the drag operation is accelerating. In this case, based on the above-described expression (3), the correction value Vdx can be expressed by following expression (4). That is, in this case, the correction value Vdx is equivalent to the absolute value |Vd(2)| of the second operating speed Vd(2).

$$\begin{matrix}[ Formula 4 ] & \\ \begin{matrix}Vdx = \vert Vd ( 1 ) \vert - ( \vert Vd ( 1 ) \vert - \vert Vd ( 2 ) \vert ) \\ = \vert Vd ( 2 ) \vert\end{matrix} & ( 4 )\end{matrix}$$

In addition, as indicated by the above-described condition (2), the absolute value |Vd(1)| of the first operating speed Vd(1) and the absolute value |Vd(2)| of the second operating speed Vd(2) being equal means that the absolute value |Vd| of the operating speed Vd of the drag operation has not changed, or in other words, that the drag operation is being performed at a fixed speed. In this case, based on the above-described expression (3), the correction value Vdx can be expressed by following expression (5). That is, in this case, the correction value Vdx is equivalent to the absolute value |Vd(1)| of the first operating speed Vd(1).

$$\begin{matrix}[ Formula 5 ] & \\ \begin{matrix}Vdx = \vert Vd ( 1 ) \vert - ( \vert Vd ( 1 ) \vert - \vert Vd ( 1 ) \vert ) \\ = \vert Vd ( 1 ) \vert\end{matrix} & ( 5 )\end{matrix}$$

Furthermore, as indicated by the above-described condition (3), the absolute value |Vd(1)| of the first operating speed Vd(1) being less than the absolute value |Vd(2)| of the second operating speed Vd(2) means that the absolute value |Vd| of the operating speed Vd of the drag operation is decreasing, or in other words, that the drag operation is decelerating. In this case, based on the above-described expression (3), the correction value Vdx can be expressed by following expression (6).

$$\begin{matrix}[ Formula 6 ] & \\ \begin{matrix}Vdx = \vert Vd ( 1 ) \vert - ( \vert Vd ( 2 ) \vert - \vert Vd ( 1 ) \vert ) \\ = 2 \vert Vd ( 1 ) \vert - \vert Vd ( 2 ) \vert\end{matrix} & ( 6 )\end{matrix}$$

In this way, when the absolute value |Vd(1)| of the first operating speed Vd(1) is greater than the absolute value |Vd(2)| of the second operating speed Vd(2), that is, when the drag operation is accelerating, as indicated by condition (1), the correction value Vdx is equivalent to the absolute value |Vd(2)| of the second operating speed Vd(2), based on the above-described expression (4). In addition, when the absolute value |Vd(1)| of the first operating speed Vd(1) and the absolute value |Vd(2)| of the second operating speed Vd(2) are equal, that is, the drag operation is being performed at a fixed speed, as indicated by condition (2), the correction value Vdx is equivalent to the absolute value |Vd(1)| of the first operating speed Vd(1), based on the above-described expression (5). Therefore, in both these cases, the correction value Vdx is a value that is greater than zero.

Meanwhile, as indicated by condition (3), when the absolute value |Vd(1)| of the first operating speed Vd(1) is less than the absolute value |Vd(2)| of the second operating speed Vd(2), that is, when the drag operation is decelerating, the correction value Vdx may be a negative value, based on the above-described expression (6). Therefore, when the correction value Vdx calculated based on the above-described expression (6) is a negative value, the control unit 45 sets the correction value Vdx to zero. The correction value Vdx becomes a negative value when the absolute value |Vd(1)| of the first operating speed Vd(1) is less than ½ of the absolute value |Vd(2)| of the second operating speed Vd(2), as indicated in following expression (7). That is, when a sudden deceleration such as that in which the absolute value |Vd(1)| of the first operating speed Vd(1) becomes less than ½ of the absolute value |Vd(2)| of the second operating speed Vd(2) is performed, the correction value Vdx may become a negative value in the above-described expression (6).

[Formula 7]

2|Vd(1)|−|Vd(2)|<0

2|Vd(1)|<2|Vd(2)|

|Vd(1)|<|Vd(2)|/2 (7)

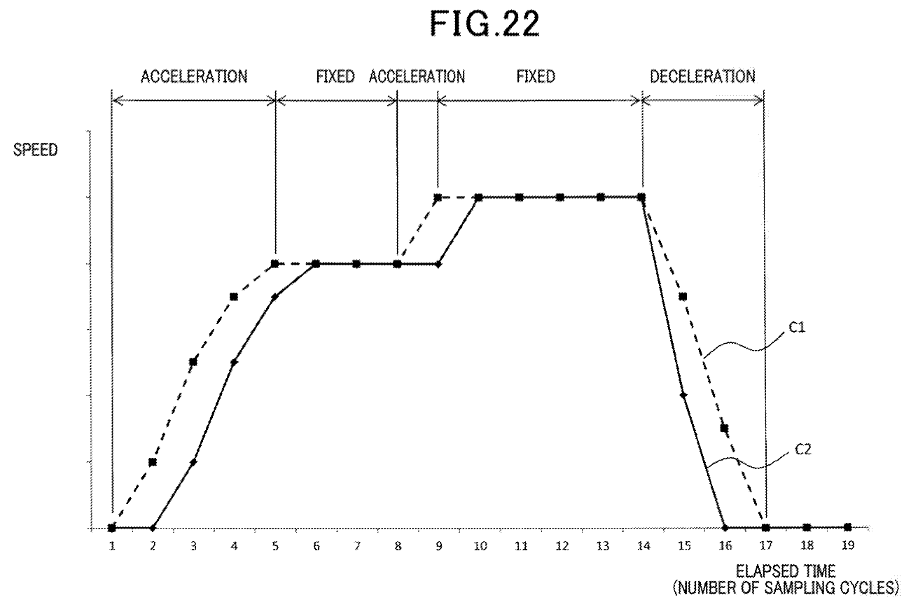

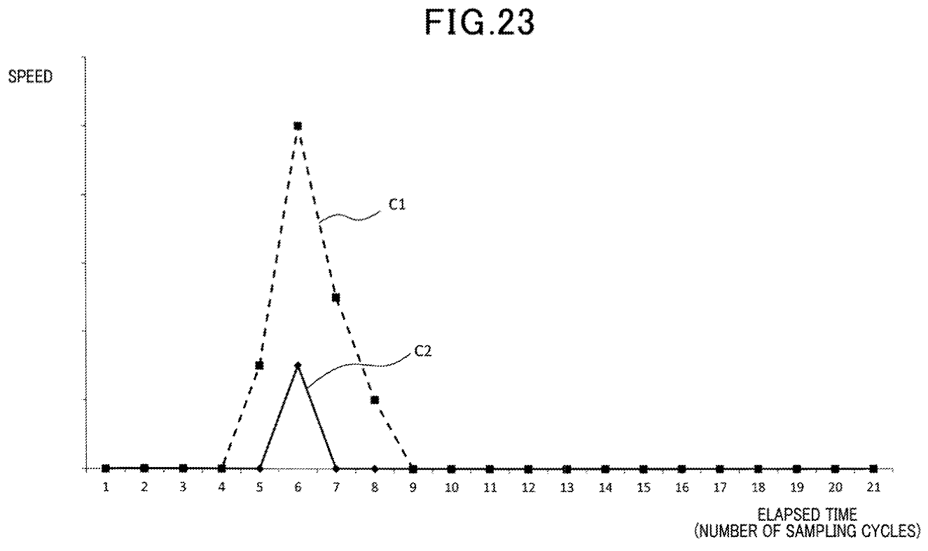

Next, working effects of the above-described configuration will be described with reference also to FIG. 22 and FIG. 23. Broken lines C1 shown in FIG. 22 and FIG. 23 indicate the absolute value |Vd|, over time, of the operating speed Vd of a drag operation in a certain mode, when the drag operation is inputted. Solid lines C2 indicate the correction value Vdx that is calculated based on the absolute value |Vd| indicated by the broken line C1.

As shown in FIG. 22, in the segment over which the drag operation is accelerating (referred to, hereafter, as an acceleration segment), the correction value Vdx becomes the absolute value |Vd(2)| of the second operating speed Vd(2), as indicated by the above-described expression (4). Therefore, during this acceleration segment, the correction value Vdx does not exceed the absolute value |Vd(1)| of the first operating speed Vd(1), which is the absolute value |Vd| of the operating speed Vd of the current drag operation. In addition, in the segment over which the drag operation is being performed at a fixed speed (referred to, hereafter, as a fixed segment), the correction value Vdx becomes the absolute value |Vd(1)| of the first operating speed Vd(1), as indicated by the above-described expression (5). Therefore, during this fixed segment as well, the correction value Vdx does not exceed the absolute value |Vd(1)| of the first operating speed Vd(1), which is the absolute value |Vd| of the operating speed Vd of the current drag operation.

Furthermore, in the segment over which the drag operation is decelerating (referred to, hereafter, as a deceleration segment), |Vd(1)|<|Vd(2)|. In this case, based on the above-described expression (6), the relationship between the correction value Vdx and the absolute value |Vd(1)| of the first operating speed Vd(1) becomes following expression (8). That is, during this deceleration segment, the correction value Vdx becomes less than the absolute value |Vd(1)| of the first operating speed Vd(1). Therefore, during this deceleration segment as well, the correction value Vdx does not exceed the absolute value |Vd(1)| of the first operating speed Vd(1), which is the absolute value |Vd| of the operating speed Vd of the current drag operation. That is, the correction value Vdx does not exceed the absolute value |Vd(1)| of the first operating speed Vd(1), during all of the acceleration segment, the fixed segment, and the deceleration segment,

$$\begin{matrix}[ Formula 8 ] & \\ Vdx = 2 \vert Vd ( 1 ) \vert - \vert Vd ( 2 ) \vert < 2 \vert Vd ( 1 ) \vert - \vert Vd ( 1 ) \vert < 2 \vert Vd ( 1 ) \vert & ( 8 )\end{matrix}$$

In this way, according to the preset embodiment, in the motion speed determining process, the correction value Vdx is zero when the absolute value |Vd(1)| of the first operating speed Vd(1) is less than ½ of the absolute value |Vd(2)| of the second operating speed Vd(2). In the motion speed determining process, the correction value Vdx is a value obtained by the difference between the absolute value |Vd(1)| of the first operating speed Vd(1) and the absolute value |Vd(2)| of the second operating speed Vd(2) being subtracted from the absolute value |Vd(1)| of the first operating speed Vd(1), when the absolute value |Vd(1)| of the first operating speed Vd(1) is equal to or greater than ½ of the absolute value |Vd(2)| of the second operating speed Vd(2).

As a result, as shown in FIG. 22, the correction value Vdx becomes equal to or less than the absolute value |Vd(1)| of the first operating speed Vd(1) during all of the acceleration segment, the fixed segment, and the deceleration segment. Therefore, the motion speed Vr of the robot 20 or 30 is not determined based on a value that exceeds the absolute value |Vd(1)| of the first operating speed Vd(1), which is the current operating speed Vd. In other words, as shown in FIG. 23, for example, even when a sudden drag operation that is unintended by the user is inputted, the correction value Vdx is a value equal to or less than the absolute value |Vd(1)| of the first operating speed Vd(1), which is the current operating speed Vd. Therefore, in a case in which the user performs an operation on the touch panel 421 such that the motion speed Vr of the robot 20 or 30 is determined based on the operation by the user, acceleration at the time of initial input can be suppressed. As a result, a sudden drag operation that is unintended by the user being directly reflected in the motion speed Vr of the robot 20 or 30 can be prevented. Consequently, the robot 20 or 30 operating in a mode unintended by the user can be prevented to the greatest possible extent. As a result, safety is improved.

In addition, the correction value Vdx is equal to or less than the absolute value |Vd(1)| of the first operating speed Vd(1) at all times. Therefore, when the robot 20 or 30 is decelerated, the robot 20 or 30 decelerates more quickly than the deceleration in the operating speed Vd of the user. Therefore, for example, when the user wishes to stop operation of the robot 20 or 30, the user can promptly stop the robot 20 or 30, and safety is achieved. In this way, according to the present embodiment, during acceleration, acceleration of the robot 20 or 30 can be suppressed in relation to the operating speed Vd of the user. During deceleration, the robot 20 or 30 can be decelerated more quickly than the operating speed Vd of the user. Therefore, safety can be improved during both acceleration and deceleration of the robot 20 or 30.

### Fourth Embodiment

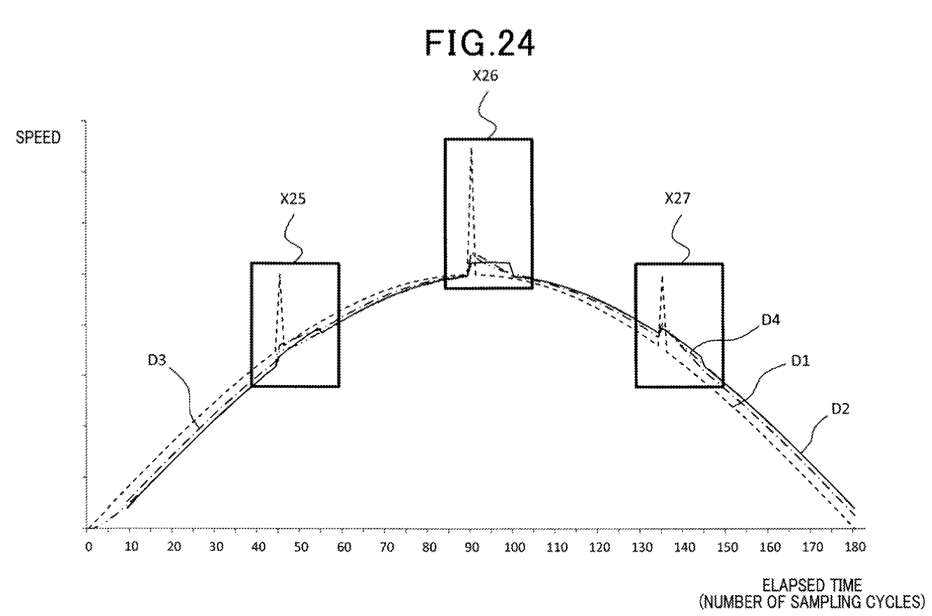

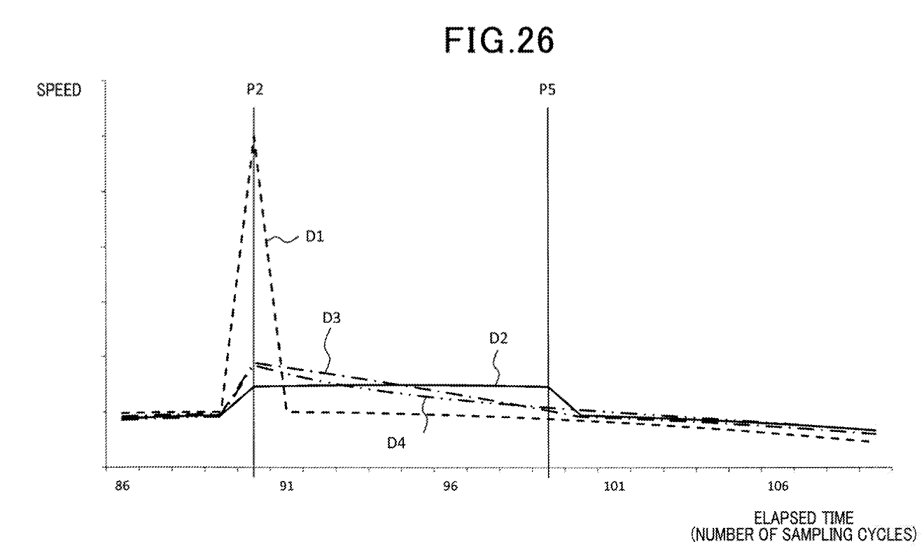

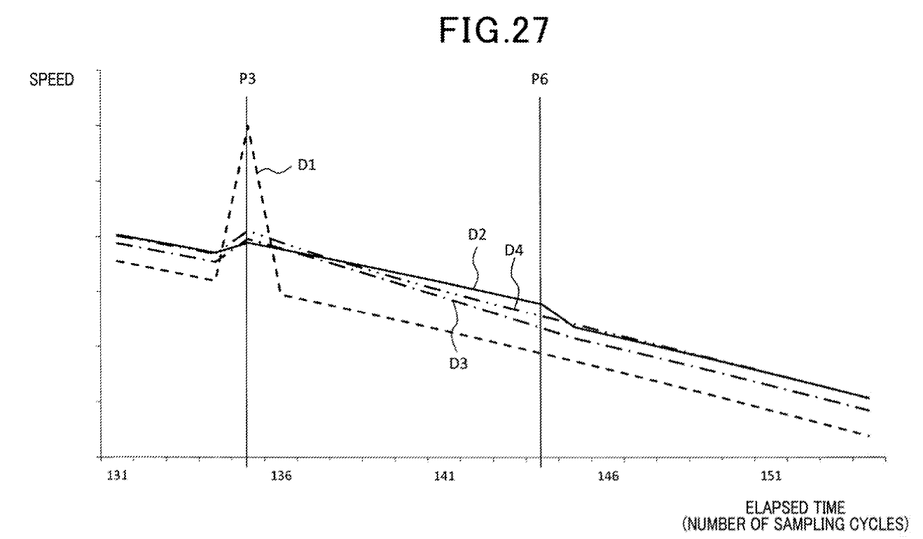

Next, a fourth embodiment will be described with reference also to FIG. 24 to FIG. 27. The robot system 10 according to the present embodiment is also characteristic in terms of the method for calculating the motion speed Vr of the robot 20 or 30 in the motion speed determining process. That is, attachment of oil, dirt, and the like on the touch panel 421 of the teaching pendant 40 or the finger of the user, on site where the robot 20 or 30 is handled, is presumed.

For example, when oil attaches to the touch panel 421 or the finger of the user, the finger of the user that is performing the drag operation tends to slide. When the finger of the user slides while performing the drag operation, the operating speed Vd of the drag operation may suddenly change. In addition, for example, when dirt attaches to the touch panel 421 or the finger of the user, the finger of the user that is performing the drag operation has difficulty sliding. In this case, so-called chatter occurs in the finger of the user performing the drag operation. In such situations, when the motion speed Vr of the robot 20 or 30 is merely a value that simply references the operating speed Vd of the current drag operation, that is, merely a value that is simply proportional to the absolute value |Vd| of the operation speed Vd, the sudden changes in speed of the drag operation and the vibrational changes in speed of the drag operation are directly reflected in the motion speed Vr of the robot 20 or 30. The robot 20 or 30 may then operate in a mode unintended by the user.

Therefore, in a manner similar to the above-described third embodiment, the robot system 10 according to the present embodiment includes the storage area 452 that is capable of storing therein the operating speed Vd of a drag operation at a fixed sampling cycle. The motion speed determining process includes a process in which a moving average value of the absolute values |Vd| of a plurality of, such as an n-number of, previous operating speeds Vd is set as the correction value Vdx, and the motion speed of the robot 20 or 30 is determined based on the correction value Vdx.

Here, representative examples of the moving average include a simple moving average, a weighted moving average, and an exponential moving average. In this case, the correction value Vdx based on the simple moving average is a simple moving average value VdS. The correction value Vdx based on the weighted moving average is a weighted moving average value VdW. The correction value Vdx based on the exponential moving average is an exponential moving average value VdE. The simple moving average value VdS, the weighted moving average value VdW, and the exponential moving average value VdE are respectively calculated by following expression (9) to expression (12).

$$\begin{matrix}[ Formula 9 ] & \\ \begin{matrix}VdS = \frac{1}{n} \times {\sum }_{i = 1}^{n} \vert Vd ( i ) \vert \\ = \frac{( \vert Vd ( 1 ) \vert + \vert Vd ( 2 ) \vert + … + \vert Vd ( i - 1 ) \vert + \vert Vd ( i ) \vert}{n}\end{matrix} & ( 9 ) \\ [ Formula 10 ] & \\ \begin{matrix}VdW = \frac{{\sum }_{i = 1}^{n} ( ( n + 1 - i ) \times \vert Vd ( i ) \vert}{{\sum }_{i = 1}^{n} i} \\ = \frac{\begin{matrix}( n \times \vert Vd ( 1 ) \vert + ( n - 1 ) \times \vert Vd ( 2 ) \vert + … + \\ 2 \times \vert Vd ( n - 1 ) \vert + \vert Vd ( n ) \vert\end{matrix}}{1 + 2 + … ( n - 1 ) + n}\end{matrix} & ( 10 ) \\ [ Formula 11 ] & \\ \begin{matrix}VdE = α \times {\sum }_{i = 1}^{n} ( {( 1 - α )}^{i - 1} \times \vert Vd ( i ) \vert ) \\ = α \times ( \vert Vd ( 1 ) \vert + ( 1 - α ) \times \vert Vd ( 2 ) \vert + … \\ {( 1 - α )}^{n - 1} \times \vert Vd ( n ) \vert )\end{matrix} & ( 11 ) \\ [ Formula 12 ] & \\ α = 2 / ( n ; 1 ) & ( 12 )\end{matrix}$$

As indicated in above-described expression (9), the simple moving average value VdS is a value obtained by the absolute values |Vd| of the plurality of, or in this case, the n-number of previous operating speeds Vd being summated, and the sum value being divided by the n-number of the operating speeds Vd. As a result of the simple moving average value VdS, sudden changes in speed of the operating speeds Vd of the drag operation can be smoothened to a certain extent. Therefore, with the simple moving average value VdS as well, the working effect of sudden changes in speed or vibrational changes in speed of the drag operation not being directly reflected in the motion speed Vr of the robot 20 or 30 is achieved to a certain extent. However, the instant a value that indicates a sudden change in speed is no longer included among the plurality of operating speeds Vd to be averaged, the simple moving average value VdS significantly changes so as to return to the actual, not-averaged operating speed Vd. Consequently, the simple moving average value VdS significantly changes regardless of the operating speed Vd of the drag operation not significantly changing. As a result, for example, a situation in which the motion speed Vr of the robot 20 or 30 unexpectedly changes regardless of the user performing operation at a fixed speed may occur. In this case, the operation of the robot 20 or 30 becomes that unintended by the user, and may cause the user discomfort or confusion.

Therefore, according to the present embodiment, the correction value Vdx is preferably the weighted moving average value VdW or the exponential moving average value VdE, rather than the simple moving average value VdS. That is, in the motion speed determining process, the motion speed Vr of the robot 20 or 30 is preferably determined based on the weighted moving average value VdW or the exponential moving average value VdE of the absolute values |Vd| of the plurality of previous operating speeds Vd. As indicated by the above-described expression (10) and expression (11), the weighted moving average value VdW and the exponential moving average value VdE are calculated by the absolute values |Vd| of the plurality of, or in this case, the n-number of previous operating speeds Vd being weighted by predetermined coefficients. In this case, the coefficient for the weighted moving average value VdW is a coefficient that linearly decreases as the operating speed becomes older. The coefficient for the exponential moving average value VdW is a coefficient that exponentially decreases as the operating speed becomes older.

Next, working effects of the above-described configuration will be described with reference also to FIG. 24 to FIG. 27. Broken lines D1 shown in FIG. 24 to FIG. 27 indicate the absolute value |Vd|, over time, of the operating speed Vd of a drag operation in a certain mode, when the drag operation is inputted. Solid lines D2 indicate the simple moving average value VdS calculated based on the absolute value |Vd| indicated by the broken line D1. Single-dot chain lines D3 indicate the weighted moving average value VdW calculated based on the absolute value |Vd| indicated by the broken line D1. Two-dot chain lines D4 indicate the exponential moving average value VdE calculated based on the absolute value |Vd| indicated by the broken line D1.

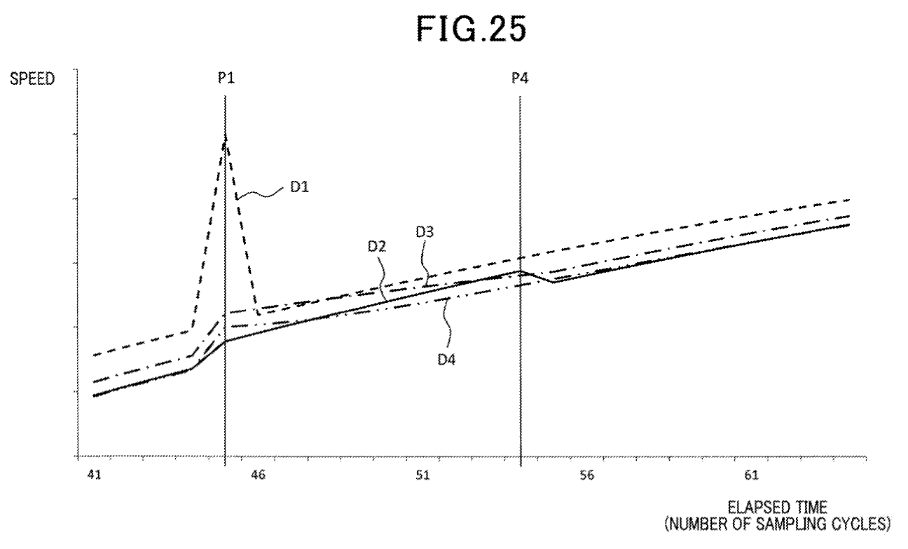

As shown in FIG. 25 to FIG. 27, the absolute value |Vd| of the operating speed Vd indicated by the broken line D1 changes suddenly at points P1 to P3. In this case, as is clear from FIG. 25 to FIG. 27, the moving average values VdS, VdW, and VdE each suppress the sudden change in operating speed Vd occurring at points P1 to P3. In addition, points P4 to P6 in FIG. 25 to FIG. 27 are points at which the value indicating a sudden change in speed, that is, the operating speed Vd at points P1 to P3, is no longer included in the n-number of operating speeds Vd to be averaged. In this case, the simple moving average value VdS indicated by the solid lines D2 indicates a relatively significant change at points P4 to P6.

In other words, the weighted moving average value VdW and the exponential moving average value VdE are greater than the simple moving average value VdS immediately after the sudden change occurs in the operating speed Vd, that is, at the stage immediately after points P1 to P3. However, thereafter, the weighted moving average value VdW and the exponential moving average value VdE smoothly approach and track the absolute value |Vd| of the operating speed Vd without the occurrence of sudden changes. Meanwhile, at the stage immediately after the sudden change occurs in the operating speed Vd, the simple moving average value VdS is less than the weighted moving average value VdW and the exponential moving average value VdE. The simple moving average value VdS then transitions in parallel with the absolute value |Vd| of the operating speed Vd for a time. Subsequently, before reaching points P4 to P6, the simple moving average value VdS reverses position with the weighted moving average value VdW and the exponential moving average value VdE. When the value indicating the sudden change in speed is no longer included in the n-number of operating speeds Vd to be averaged, that is, when points P1 to P3 are reached, the simple moving average value VdS significantly changes to approach the absolute value |Vd| of the operating speed Vd.

In this way, according to the present embodiment, the control unit 45 determines the motion speed Vr of the robot 20 or 30 based on the moving average value of the absolute values |Vd| of the plurality of previous operating speeds Vd. As a result, the operating speeds Vd of the drag operation can be averaged, that is, smoothened. Therefore, even when the finger of the user slides and a sudden change in speed occurs in the drag operation, the motion speed Vr of the robot 20 or 30 can be determined based on the moving average value in which the sudden change in speed is smoothened, that is, a value in which the sudden change in speed is reduced. In addition, even when, for example, chatter occurs with the finger of the user and a vibrational change in speed occurs in the drag operation, the motion speed Vr of the robot 20 or 30 can be determined based on the moving average value in which the vibrational sudden change in speed is smoothened and made smooth. Therefore, sudden changes in speed or vibrational changes in speed of the drag operation being directly reflected in the motion speed Vr of the robot 20 or 30 can be suppressed. As a result, the robot operating in a mode unintended by the user can be prevented to the greatest possible extent. Safety is improved.

In addition, according to the present embodiment, the control unit 45 determines the motion speed Vr of the robot 20 or 30 based on the weighted moving average value VdW or the exponential moving average value VdE of the absolute values |Vd| of the operating speeds Vd of the drag operation. As a result, because the values to be averaged are weighted, even when a value indicating a sudden change in speed is no longer included in the plurality of operating speeds Vd to be averaged, the weighted moving average value VdW and the exponential moving average value VdE indicate a smooth change. Therefore, according to this embodiment, a phenomenon in which the motion speed Vr of the robot 20 or 30 significantly changes regardless of the operating speed Vd of the drag operation not significantly changing can be suppressed. As a result, the user can operate the robot as intended, without discomfort.

The embodiments of the present invention are not limited to the embodiments described above and shown in the drawings. Modifications can be made accordingly without departing from the spirit of the invention. The embodiments of the present invention may include, for example, the following modifications or expansions. According to each of the above-described embodiments, the touch panel 421 and the display 422 are integrally configured as the touch panel display 42. However, the touch panel and the display may be configured to be separated from each other as individual components. In this case, a direction graphics indicating a specific linear direction can be provided on the touch panel in advance by printing or the like.

In addition, the robot to be operated by the teaching pendant 40 according to the above-described embodiments is not limited to the four-axis robot 20 or the six-axis robot 30. For example, the robot may be the four-axis robot 20 or the six-axis robot 30 set on a so-called X-Y stage (two-axis stage). In addition, the robot to be operated by the teaching pendant 40 includes, for example, a linear-type robot having a single drive axis and an orthogonal-type robot having a plurality of drive axes. In this case, the drive axis is not limited to a mechanical rotating shaft and also includes, for example, a drive axis that is driven by a linear motor.

1-10. (canceled)

11. An apparatus for operating a robot, the apparatus comprising:
a touch panel that receives input of a touch operation and a drag operation from a user;
an operation detecting unit that is capable of detecting the touch operation and the drag operation on the touch panel; and
a motion command generating unit that generates a motion command for operating the robot based on a detection result from the operation detecting unit, wherein
the motion command generating unit performs
a motion direction determining process in which a motion direction of the robot is determined, and
a motion speed determining process in which, when the operation detecting unit detects a drag operation in a positive or negative direction in a specific linear direction on the touch panel after the motion direction determining process is performed, a motion speed at which to operate the robot in the motion direction determined in the motion direction determining process is determined based on an absolute value of an operating speed of the drag operation.

12. The apparatus according to claim 11, wherein:
the motion direction determining process includes a process in which the motion direction of the robot is determined to be a positive direction when the operating direction immediately after start of the drag operation is the positive direction in the specific linear direction, and the motion direction of the robot is determined to be a negative direction when the operating direction immediately after start of the drag operation is the negative direction in the specific linear direction.

13. The apparatus according to claim 11, wherein:
the specific linear direction is composed of a first direction that is an arbitrary linear direction on the touch panel and a second direction that is a linear direction perpendicular to the first direction; and
the motion command generating unit performs a motion mode determining process in which a motion mode by a drive axis or a combination of drive axes of the robot is determined to be a first motion mode when the operating direction of the drag operation detected by the operation detecting unit is the first direction, and the motion mode of the robot is determined to be a second motion mode when the operating direction of the drag operation is the second direction.

14. The apparatus according to claim 11, further comprising:
a display capable of displaying graphics, and a display control unit that controls display content of the display, wherein
the display control unit performs a direction graphics display process in which, when the operation detecting unit detects the touch operation, a direction graphics indicating the specific linear direction with reference to a touch position of the touch operation is displayed on the display.

15. The apparatus according to claim 11, further comprising:
a display capable of displaying graphics, and a display control unit that controls display content of the display, wherein
the display control unit performs an operation graphics display process in which, when the operation detecting unit detects the drag operation in the specific linear direction, an operation graphics that changes in aspect in accompaniment with movement of a current position of the drag operation is displayed on the display.

16. The apparatus according to claim 15, wherein:
the operation graphics has a bar that is formed in a linear shape extending in the specific linear direction, and a slider that is capable of moving along the bar in accompaniment with the drag operation and indicates the current position of the drag operation in relation to the bar.

17. The apparatus according to claim 11, further comprising:
a storage area that is capable of storing therein the operating speed of the drag operation at a fixed sampling cycle, wherein
the motion speed determining process includes a process in which a correction value that is a corrected absolute value of the operating speed of the drag operation is calculated and the motion speed is determined based on the correction value, and when an operating speed of a current drag operation is a first operating speed and an operating speed of a drag operation at a predetermined sampling cycle before a current sampling cycle is a second operating speed, the correction value is zero when an absolute value of the first operating speed is less than half of an absolute value of the second operating speed, and the correction value is a value obtained by a difference between the absolute value of the first operating speed and the absolute value of the second operating speed being subtracted from the absolute value of the first operating speed when the absolute value of the first operating speed is equal to or greater than half of the absolute value of the second operating speed.

18. The apparatus according to claim 11, further comprising:
a storage area that is capable of storing therein the operating speed of the drag operation at a fixed sampling cycle, wherein
the motion speed determining process includes a process in which the motion speed of the robot is determined based on a moving average value of absolute values of a plurality of previous operating speeds.

19. The apparatus according to claim 18, wherein:
the moving average value is a weighted moving average value or an exponential moving average value.

20. The apparatus according to claim 12, wherein:
the specific linear direction is composed of a first direction that is an arbitrary linear direction on the touch panel and a second direction that is a linear direction perpendicular to the first direction; and
the motion command generating unit performs a motion mode determining process in which a motion mode by a drive axis or a combination of drive axes of the robot is determined to be a first motion mode when the operating direction of the drag operation detected by the operation detecting unit is the first direction, and the motion mode of the robot is determined to be a second motion mode when the operating direction of the drag operation is the second direction.

21. The apparatus according to claim 20, further comprising:
a display capable of displaying graphics, and a display control unit that controls display content of the display, wherein
the display control unit performs a direction graphics display process in which, when the operation detecting unit detects the touch operation, a direction graphics indicating the specific linear direction with reference to a touch position of the touch operation is displayed on the display.

22. The apparatus according to claim 21, further comprising:
a display capable of displaying graphics, and a display control unit that controls display content of the display, wherein
the display control unit performs an operation graphics display process in which, when the operation detecting unit detects the drag operation in the specific linear direction, an operation graphics that changes in aspect in accompaniment with movement of a current position of the drag operation is displayed on the display.

23. The apparatus according to claim 22, wherein:
the operation graphics has a bar that is formed in a linear shape extending in the specific linear direction, and a slider that is capable of moving along the bar in accompaniment with the drag operation and indicates the current position of the drag operation in relation to the bar.

24. The apparatus according to claim 12, further comprising:
a display capable of displaying graphics, and a display control unit that controls display content of the display, wherein
the display control unit performs a direction graphics display process in which, when the operation detecting unit detects the touch operation, a direction graphics indicating the specific linear direction with reference to a touch position of the touch operation is displayed on the display.

25. The apparatus according to claim 24, further comprising:
a display capable of displaying graphics, and a display control unit that controls display content of the display, wherein
the display control unit performs an operation graphics display process in which, when the operation detecting unit detects the drag operation in the specific linear direction, an operation graphics that changes in aspect in accompaniment with movement of a current position of the drag operation is displayed on the display.

26. The apparatus according to claim 25, wherein:
the operation graphics has a bar that is formed in a linear shape extending in the specific linear direction, and a slider that is capable of moving along the bar in accompaniment with the drag operation and indicates the current position of the drag operation in relation to the bar.

27. The apparatus according to claim 12, further comprising:
a display capable of displaying graphics, and a display control unit that controls display content of the display, wherein
the display control unit performs an operation graphics display process in which, when the operation detecting unit detects the drag operation in the specific linear direction, an operation graphics that changes in aspect in accompaniment with movement of a current position of the drag operation is displayed on the display.

28. The apparatus according to claim 27, wherein:
the operation graphics has a bar that is formed in a linear shape extending in the specific linear direction, and a slider that is capable of moving along the bar in accompaniment with the drag operation and indicates the current position of the drag operation in relation to the bar.

29. A computer-executed program for operating a robot, the program being installed in an apparatus for operating the robot, the apparatus comprising
a touch panel that receives input of a touch operation and a drag operation from a user;
an operation detecting unit that is capable of detecting the touch operation and the drag operation on the touch panel; and
a motion command generating unit that generates a motion command for operating the robot based on a detection result from the operation detecting unit, wherein
the program enables the computer to perform:
a motion direction determining process in which a motion direction of the robot is determined, and
a motion speed determining process in which, when the operation detecting unit detects a drag operation in a positive or negative direction in a specific linear direction on the touch panel after the motion direction determining process is performed, a motion speed at which to operate the robot in the motion direction determined in the motion direction determining process is determined based on an absolute value of an operating speed of the drag operation.
